(19) United States
(12) Patent Application Publication
(10) Pub. No.: US 2017/0201644 A1
(43) Pub. Date: Jul. 13, 2017

(54) IMAGE FORMING APPARATUS AND NOTIFICATION METHOD

(71) Applicant: Takao OKAMURA, Tokyo (JP)

(72) Inventor: Takao OKAMURA, Tokyo (JP)

(21) Appl. No.: 15/399,158

(22) Filed: Jan. 5, 2017

(30) Foreign Application Priority Data
Jan. 13, 2016 (JP) 2016-004499

(51) Int. Cl. H04N 1/32; H04N 1/00

(52) U.S. Cl. CPC H04N 1/32144; H04N 1/00037; H04N 1/00074; H04N 2201/0094; H04N 2201/0039; H04N 2201/3202; H04N 2201/3205; H04N 2201/3233

(57) ABSTRACT

An image forming apparatus includes a first input controller, an output controller, a second input controller, a detector, and a notifier. The first input controller is configured to receive an input concerning a request for outputting image data. The output controller is configured to output the image data onto which identification information for identifying an input user who performs the input concerning the output request received by the first input controller is embedded. The second input controller is configured to receive an input of the image data. The detector is configured to detect the identification information from the image data received by the second input controller. The notifier is configured to notify a fact that the image data is detected in a manner recognizable by the input user of the identification information when the identification information is detected by the detector from the image data.

### CROSS-REFERENCE TO RELATED APPLICATION

The present application claims priority under 35 U.S.C. §119 to Japanese Patent Application No. 2016-004499, filed Jan. 13, 2016. The contents of which are incorporated herein by reference in their entirety.

### BACKGROUND OF THE INVENTION

1. Field of the Invention

The present invention relates to an image forming apparatus and a notification method.

2. Description of the Related Art

There is a situation where a user of an image forming apparatus such as a copying machine neglects to collect a printed material which the image forming apparatus is caused to print and leaves the printed material. Then, various techniques which prevent the printed material from being left have been disclosed.

In the technique disclosed in Japanese Unexamined Patent Application Publication No. 2014-178848, a print device transmits, when a user causes the print device to print a printed material, a mail that prevents neglecting to take the printed material, to the user. The print device then transmits, to a security administrator and the like, a mail indicating that there arises a neglect of taking the printed material, when no response is returned within a wait time. It is accordingly described that the technique disclosed in Japanese Unexamined Patent Application Publication No. 2014-178848 is capable of preventing the neglect of taking the printed material.

However, it is not possible when a third party finds an output material such as the left printed material to cope with a situation where the finder is unable to recognize who has output the found output material.

### SUMMARY OF THE INVENTION

According to one aspect of the present invention, an image forming apparatus includes a first input controller, an output controller, a second input controller, a detector, and a notifier. The first input controller is configured to receive an input concerning a request for outputting image data. The output controller is configured to output the image data onto which identification information for identifying an input user who performs the input concerning the output request received by the first input controller is embedded. The second input controller is configured to receive an input of the image data. The detector is configured to detect the identification information from the image data received by the second input controller. The notifier is configured to notify a fact that the image data is detected in a manner recognizable by the input user of the identification information when the identification information is detected by the detector from the image data.

### BRIEF DESCRIPTION OF THE DRAWINGS

FIG. 1 illustrates an example of a configuration of a print system according to an embodiment;

FIG. 2 is a block diagram of an example of a hardware configuration of an MFP;

FIG. 3 is an explanatory view of a data structure of a user table;

FIG. 4 is an explanatory view of a data structure of a job log table;

FIG. 5 is an explanatory view of a data structure of an image log table;

FIG. 6 is an explanatory view of a data structure of an alert table;

FIG. 7 illustrates a software configuration of the MFP according to the embodiment;

FIG. 8 is a block diagram of an example of a hardware configuration of an information processing device;

FIG. 9 is a block diagram of an example of a hardware configuration of a server device;

FIG. 10 is a block diagram of an example of a functional block indicating a configuration of characteristic functions provided in the MFP according to the embodiment;

FIG. 11 is an explanatory view of a data structure of output material information;

FIG. 12 is a block diagram of an example of a functional block indicating a configuration of characteristic functions provided in the information processing device according to the embodiment;

FIG. 13 is a block diagram of an example of a functional block indicating a configuration of characteristic functions provided in the server device according to the embodiment;

FIG. 14 is a flowchart of an example of an operation of the MFP according to the embodiment;

FIG. 15 is a flowchart of an example of an initial setting processing;

FIG. 16 is an explanatory view of an example of a screen for administrator initial setting;

FIG. 17 is an explanatory view of an example of a screen for recording setting;

FIG. 18 is an explanatory view of an example of a screen for notification setting;

FIG. 19 is an explanatory view of an example of a screen for output material information addition setting;

FIG. 20 is an explanatory view of an example of a screen for detection time output setting;

FIG. 21 is an explanatory view of an example of a screen for initial setting;

FIG. 22 is an explanatory view of an example of a screen for embedment setting;

FIG. 23 is an explanatory view of an example of a screen for self-notification;

FIG. 24 is a flowchart of an example of an execution processing;

FIG. 25 is an explanatory view of an example of an alert screen;

FIG. 26 is an explanatory view of an example of a screen for function selection;

FIG. 27 is a flowchart of an example of an output material information detection mode processing;

FIG. 28 is an explanatory view of an example of a screen for finder notification setting;

FIG. 29 is an explanatory view of an example of a detection result screen;

FIG. 30 is a flowchart of an example of an output user notification setting processing;

FIG. 31 is an explanatory view of an example of an SNS screen;

FIG. 32 is an explanatory view of an example of a mail screen;

FIG. 33 is a flowchart of an example of an output material information detecting processing;

FIG. 34 is a flowchart of an example of an output material information embedment output processing;

FIG. 35 is an explanatory view of an example of a screen for embedment selection; and

FIG. 36 is a flowchart of an example of an output processing.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the drawings.

An object of an embodiment is to provide an image forming apparatus and a notification method which are capable of notifying the user who has output the output material of a detection of the output material.

While a situation in which an image forming apparatus is applied to a multifunction peripheral (hereinafter referred to as “MFP”) will be taken as an example and explained below, the present invention is not limited thereto. Here, the multifunction peripheral is a device including at least two of a copying function, a scanner function, a facsimile function, and a printing function. The embodiment to be explained below is one mode of an image forming apparatus and a notification method and is not intended to limit the configuration and the specification thereof.

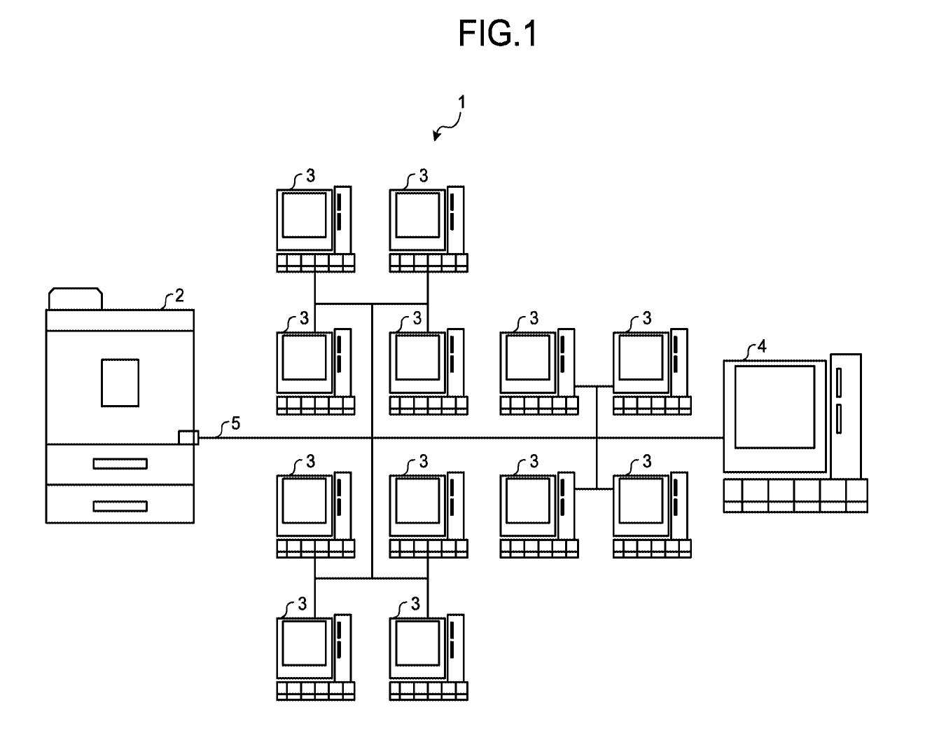

FIG. 1 illustrates an example of a configuration of a print system 1 according to an embodiment. The print system 1 is provided with an MFP 2, an information processing device 3, and a server device 4. In the print system 1 illustrated in FIG. 1, one MFP 2, twelve information processing devices 3, and one server device 4 are depicted. However, the print system 1 may be provided with a plurality of MFPs 2 and server devices 4. Besides, the number of the information processing devices 3 provided in the print system 1 may be less than or more than twelve.

The MFP 2, the information processing devices 3, and the server device 4 are mutually connected via a network 5 such as the Internet. A communication method for the connection to the network 5 may be wired or wireless. Alternatively, the connection to the network 5 may be realized by a combined communication method with the wired and wireless communications.

The MFP 2 is arranged in an office of a user and the like. The MFP 2 then uses a technique such as an electronic watermark to embed a user ID and the like onto an output material in outputting the output material. Here, the output material is a printed material printed by the MFP 2, an image generated through a scanner function and the like by the MFP 2, and the like. When reading an output material onto which information such as the user ID is embedded, the MFP 2 notifies the information processing device 3 used by a user corresponding to the user ID embedded onto the output material of the fact that the output material is detected.

The information processing device 3 is a personal computer and the like used by each user. The information processing device 3 notifies the fact that an output material is detected when receiving a notification from the MFP 2.

The server device 4 is a personal computer and the like used by an administrator of the MFP 2. The server device 4 stores data of various kinds. Specifically, the server device 4 stores a log on a neglect of collecting an output material and the like.

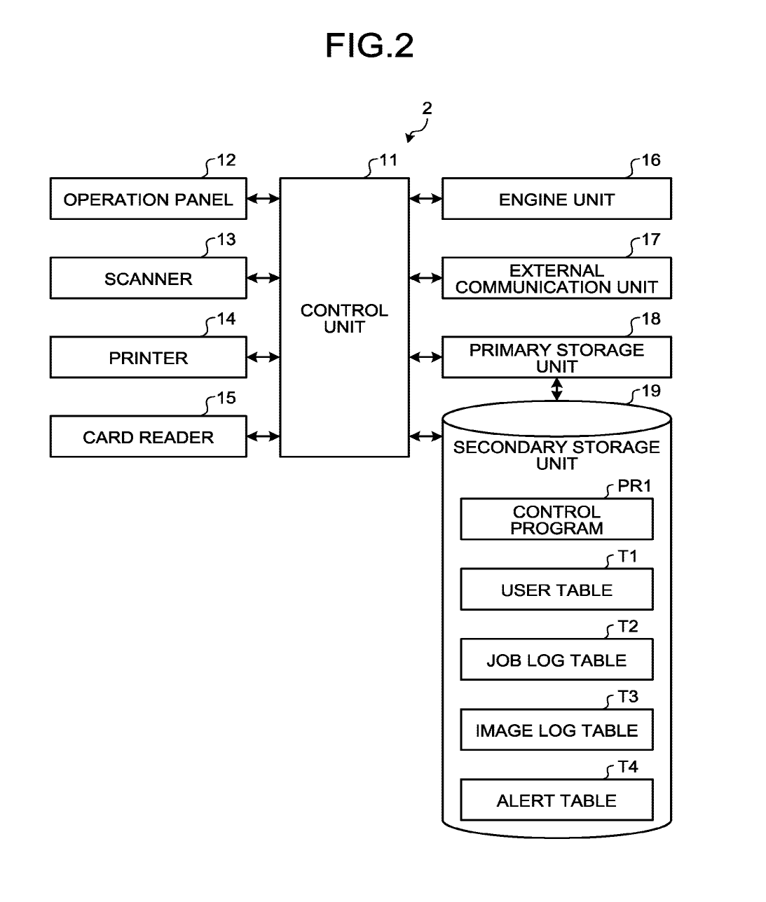

Next, a hardware configuration of the MFP 2 will be explained. FIG. 2 is a block diagram of an example of a hardware configuration of the MFP 2.

The MFP 2 is provided with a control unit 11, an operation panel 12, a scanner 13, a printer 14, a card reader 15, an engine unit 16, an external communication unit 17, a primary storage unit 18, and a secondary storage unit 19.

The control unit 11 is a computing device such as a CPU (Central Processing Unit) that controls an entire operation of the MFP 2.

The operation panel 12 as a display unit is, for example, a liquid crystal display (LCD) device provided with a touch sensor. The operation panel 12 receives an operation by a user and displays information of various kinds including information depending on a received input, information indicating an operational status of the MFP 2, and information indicating a setting condition. The operation panel 12 may be configured by an organic EL (Electro Luminescence) display device provided with a touch sensor. Moreover, the operation panel 12 may be provided with an operation unit such as a hardware key and a display unit such as a lamp.

The scanner 13 scans a document and generates image data. The scanner 13 then outputs the generated image data to a storage medium. The printer 14 forms onto a recording medium such as paper and outputs an image of the document. The card reader 15 reads information stored in a storage medium of a card. The card reader 15 then reads out a user ID from the storage medium of a user card that allows identifying a user.

The engine unit 16 is a hardware that performs versatile information processing to realize the copying function, the scanner function, the facsimile function, and the printing function and performs a processing other than communication. The engine unit 16 is provided with a scanner function of scanning and reading out an image of a document, a plotter function of performing printing onto a sheet member such as paper, and the like, for example.

The external communication unit 17 is a communication interface for connection to various kinds of devices via the network 5.

The primary storage unit 18 is a volatile memory, for example. The primary storage unit 18 is a storage area that functions as a work area in which an input image, for example, is expanded and temporarily retains the expanded image data.

The secondary storage unit 19 is a non-volatile storage device such as an HDD (Hard Disk Drive) and an SSD (Solid State Drive), for example. The secondary storage unit 19 stores a control program PR1, a user table T1, a job log table T2, an image log table T3, and an alert table T4. The control program PR1 is software that enables fulfilling the functions included in the MFP 2.

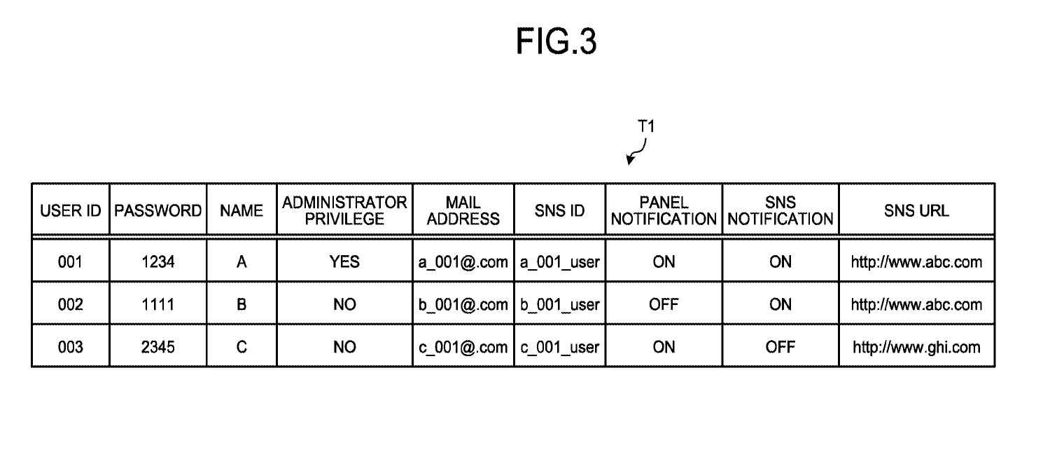

FIG. 3 is an explanatory view of a data structure of the user table T1. The user table T1 is a data table that stores user information of a user who uses the MFP 2. The user table T1 stores, by associating with each other, a user ID, a password, a name, an administrator privilege, a mail address, an SNS ID (Social Networking Service Identification), a panel notification, an SNS notification, and an SNS URL (Social Networking Service Uniform Resource Locator). The user ID is identification information for identifying a user. The password is a password that allows authenticating the user. The name is a name of the user. The administrator privilege is information indicating whether or not the user is an administrator who has an administrator privilege. The mail address is a mail address of the user. The SNS ID is identification information for identifying the user in user's SNS. The panel notification is a setting on whether or not to make a display on the operation panel 12 when a printed material whose collection is neglected by the user is detected. The SNS notification is a setting on whether or not to perform a notification by using the SNS to which the user belongs when the printed material whose collection is neglected by the user is detected. The SNS URL is a URL of the SNS to which the user belongs.

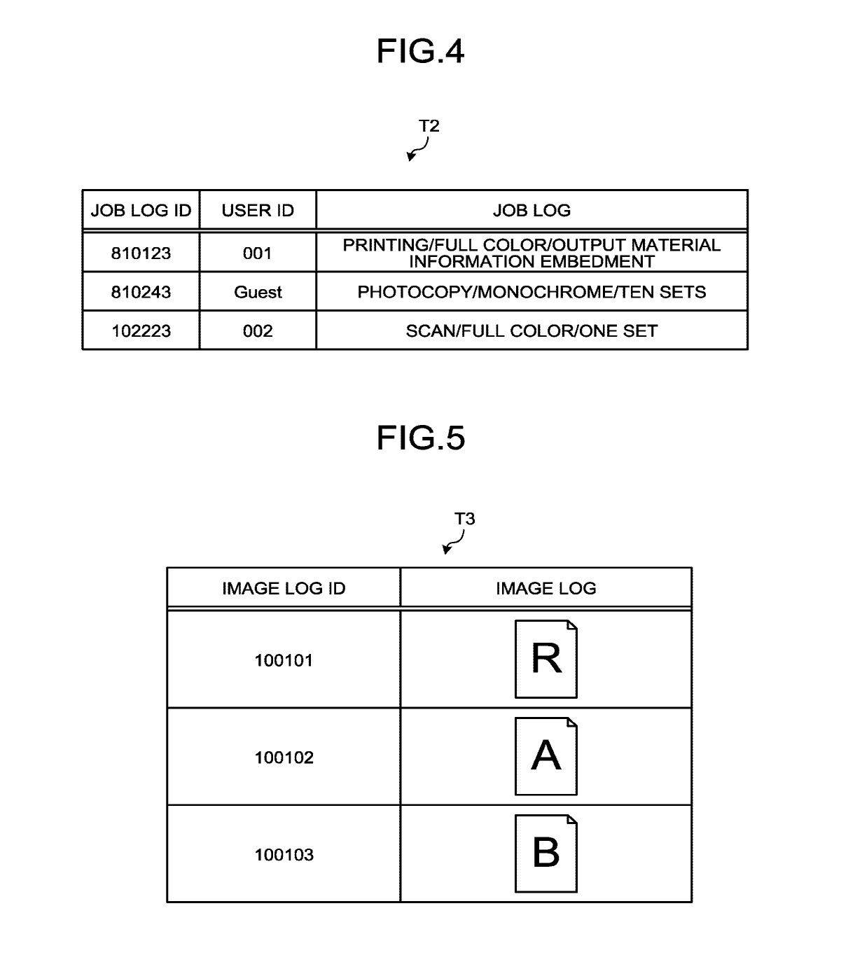

FIG. 4 is an explanatory view of a data structure of the job log table T2. The job log table T2 is a data table that stores a log of jobs executed by the MFP 2. The job log table T2 stores, by associating with each other, a job log ID, the user ID, and a job log. The job log ID is identification information for identifying a job log. The user ID is identification information indicating a user who has executed the job concerning the job log. The job log is information indicating a content of the job executed.

FIG. 5 is an explanatory view of a data structure of the image log table T3. The image log table T3 is a data table that stores an image log of the image data input to the MFP 2. The image log table T3 stores, by associating with each other, an image log ID and an image log. The image log ID is identification information for identifying an image log. The image log is information indicating image data as a processing target.

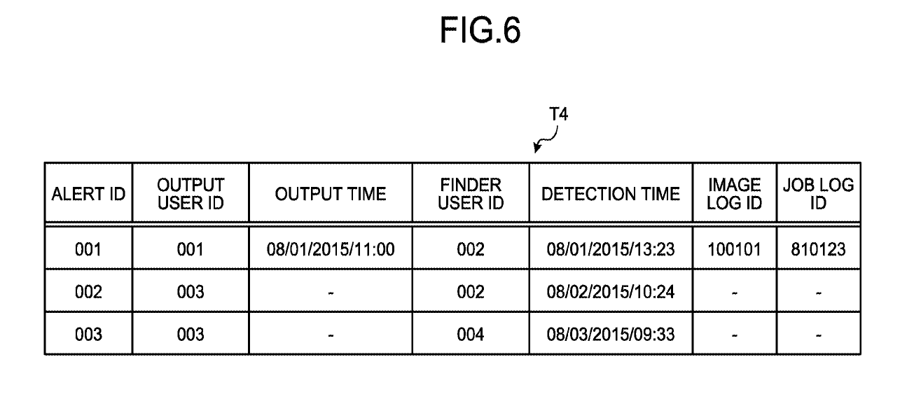

FIG. 6 is an explanatory view of a data structure of the alert table T4. The alert table T4 is a data table that stores an alert content that provides the user with an alert about a neglect of collection. The alert table T4 stores, by associating with each other, an alert ID, an output user ID, an output time, a finder user ID, a detection time, an image log ID, and a job log ID. The alert ID is identification information for identifying an alert content associated in the alert table T4. The output user ID is identification information indicating a user who has neglected to collect an output material. In other words, the output user ID is a name of the user corresponding to the user ID embedded onto the output material. The output time is information indicating a time when the output material is output. The finder user ID is identification information indicating a user who has found the output material. The detection time is information indicating a time at which the user ID embedded onto the output material and the like are detected. The image log ID is identification information indicating an image log of the output material. The job log ID is identification information indicating a job related to the output of the output material.

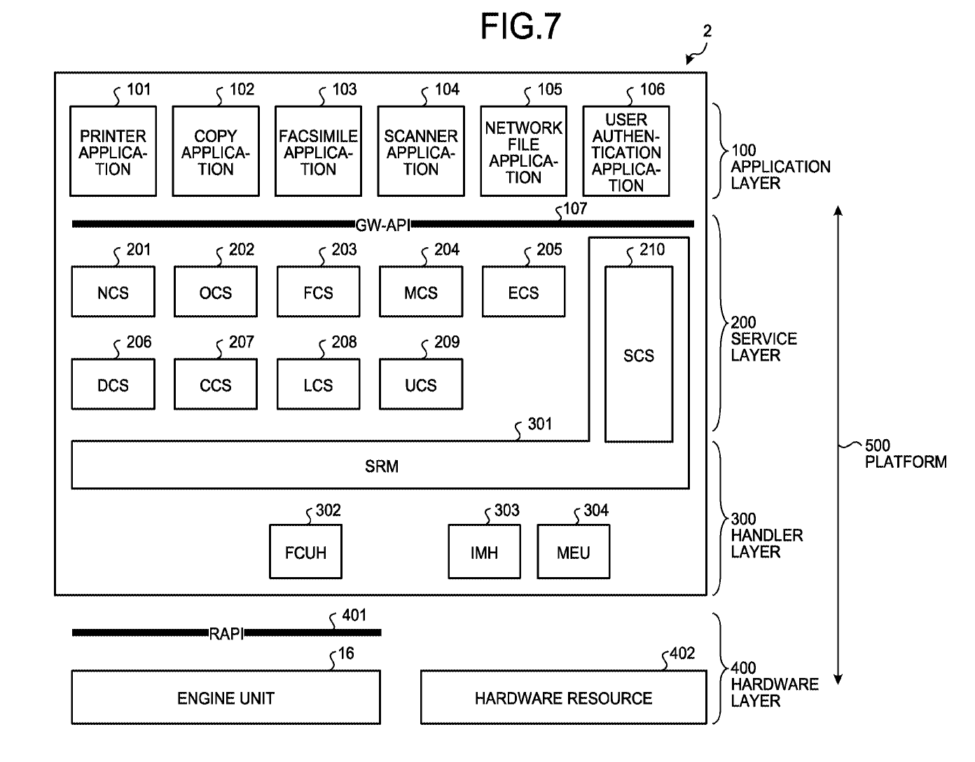

Next, a software configuration of the MFP 2 according to the embodiment will be explained. FIG. 7 illustrates a software configuration of the MFP 2 according to the embodiment. The MFP 2 is provided with an application layer 100, a service layer 200, a handler layer 300, and a hardware layer 400. The service layer 200, the handler layer 300, and the hardware layer 400 are collectively referred to as a platform 500.

The application layer 100 includes software that coordinates a control depending on each application. In response to an instruction or a request for setting from an operation screen, the application layer 100 makes a request to the platform 500 to realize the function of the application. The application layer 100 is provided with a printer application 101, a copy application 102, a facsimile application 103, a scanner application 104, a network file application 105, a user authentication application 106, and a GW-API (Gateway-Application Program Interface) 107. The printer application 101 is an application for printer. The copy application 102 is an application for copying. The facsimile application 103 is an application for facsimile. The scanner application 104 is an application for scanner. The network file application 105 is an application for a network file by which various kinds of files are shared on the network 5. The user authentication application 106 is an application for user authentication by which users are authenticated. The GW-API 107 receives processing requests from various kinds of applications of the application layer 100 by a predefined function.

The service layer 200 controls various kinds of functions included in the MFP 2. The service layer 200 is provided with an NCS (Network Control Service) 201, an OCS (Operation panel Control Service) 202, an FCS (FAX Control Service) 203, an MCS (Memory Control Service) 204, an ECS (Engine Control Service) 205, a DCS (Delivery Control Service) 206, a CCS (Certification Control Service) 207, an LCS (Log Control Service) 208, a UCS (User Control Service) 209, and an SCS (System Control Service) 210.

The NCS 201 performs an intermediation processing between the network 5 and each application of the application layer 100. The NCS 201 performs an intermediation in distributing data received by each protocol from a side of the network 5 to each application and transmitting data from each application to the side of the network 5. Specifically, the NCS 201 includes a server daemon such as ftpd, httpd, lpd, smtpd, telnetd, and smtpd, a client function of the protocol concerned, and the like.

The OCS 202 controls the operation panel 12 that receives various kinds of operations from a user. The OCS 202 performs a processing of notifying a key operation by a user, a processing of providing a library function to construct a GUI (Graphical User Interface) by each application, a processing of managing constructed GUI information for each application, a display processing on the operation panel 12, and the like.

The FCS 203 provides an API for performing a facsimile transmission/reception by using a PSTN/ISDS network, a registration/quotation of facsimile data of various kinds managed in a BKM (Backup SRAM), reading of facsimile, a facsimile reception/printing, and an integrated transmission/reception of facsimile.

The MCS 204 performs a memory control. Specifically, the MCS 204 obtains and frees image memory, uses the secondary storage unit 19, and compresses and expands image data.

The ECS 205 controls the engine unit 16 of the scanner 13, the printer 14, other hardware resource 402, and the like. The ECS 205 performs an image reading, a printing operation, a status notification, a jam recovery, and the like. Specifically, the ECS 205 sequentially issues a print request to an SRM 301 to realize a series of copying, scanning, and printing operations in accordance with a designation of a job mode received from each application.

The DCS 206 transmits and receives an image file stored in the secondary storage unit 19 and a memory on the controller by using the Simple Mail Transfer Protocol (SMTP) and the File Transfer Protocol (FTP).

The CCS 207 performs a processing concerning an authentication of users who use the MFP 2.

The LCS 208 controls log information of data processed in the MFP 2. Specifically, the LCS 208 accumulates log information of data processed by each application of the MFP 2 in the secondary storage unit 19.

The UCS 209 is a control service of managing user information registered by a user.

The SCS 210 performs a startup management and an end management of each application of the application layer 100.

The handler layer 300 controls writing and reading of data in the primary storage unit 18 and the secondary storage unit 19. The handler layer 300 controls each of units belonging to the hardware layer 400. More specifically, the handler layer 300 controls the engine unit 16 to control an input and output of image data. Moreover, the handler layer 300 controls other hardware resource 402 to perform a communication. The handler layer 300 is provided with the SRM (System Resource Manager) 301, an FCUH (Facsimile Control Unit Handler) 302, an IMH (Imaging Memory Handler) 303, and an MEU (Media Edit Utility) 304.

The SRM 301 controls the system and manages a resource together with the SCS 210. The SRM 301 performs mediation and execution control in accordance with a request from an upper layer using a hardware resource. Specifically, the SRM 301 determines whether or not the requested hardware resource is available and reports, when available, to the upper layer that the requested hardware resource is available. Besides, the SRM 301 may schedule a usage of a hardware resource in response to the request from the upper layer and directly execute a requested content.

The FCUH 302 manages a facsimile control unit.

The IMH 303 manages a memory in which image data is temporarily stored.

The MEU 304 controls hardware that performs an image conversion processing to perform an image conversion.

The hardware layer 400 controls the engine unit 16 to input and output image data and controls other hardware resource 402 to communicate with outside. An RAPI (Remote Application Programming Interface) 401 intermediates between the handler layer 300 and the engine unit 16.

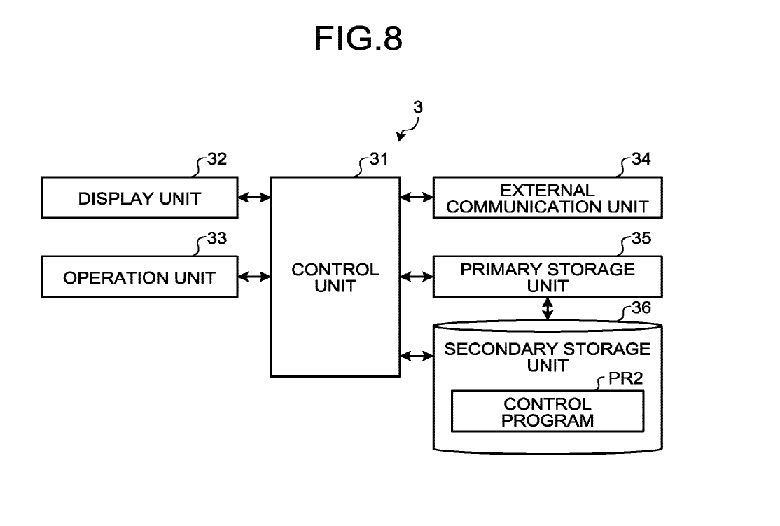

Next, a hardware configuration of the information processing device 3 will be explained. FIG. 8 is a block diagram of an example of a hardware configuration of the information processing device 3.

The information processing device 3 is provided with a control unit 31, a display unit 32, an operation unit 33, an external communication unit 34, a primary storage unit 35, and a secondary storage unit 36.

The control unit 31 is a computing device such as a CPU that controls an entire operation of the information processing device 3.

The display unit 32 is a liquid crystal display device (LCD), for example. The display unit 32 displays a screen that provides an alert to the fact that a collection of an output material output by a user who uses the information processing device 3 is neglected and the like.

The operation unit 33 is an operation device such as a keyset and a mouse. The operation unit 33 receives various kinds of inputs depending on operations by a user.

The external communication unit 34 is a communication interface for connection to various kinds of devices via the network 5.

The primary storage unit 35 is a volatile memory, for example. The primary storage unit 35 is a storage area that functions as a work area in which data of various kinds input, for example, is expanded and temporarily retains the expanded data of various kinds.

The secondary storage unit 36 is a non-volatile storage device such as an HDD and an SSD, for example. The secondary storage unit 36 stores a control program PR2. The control program PR2 is software that enables fulfilling the functions included in the MFP 2.

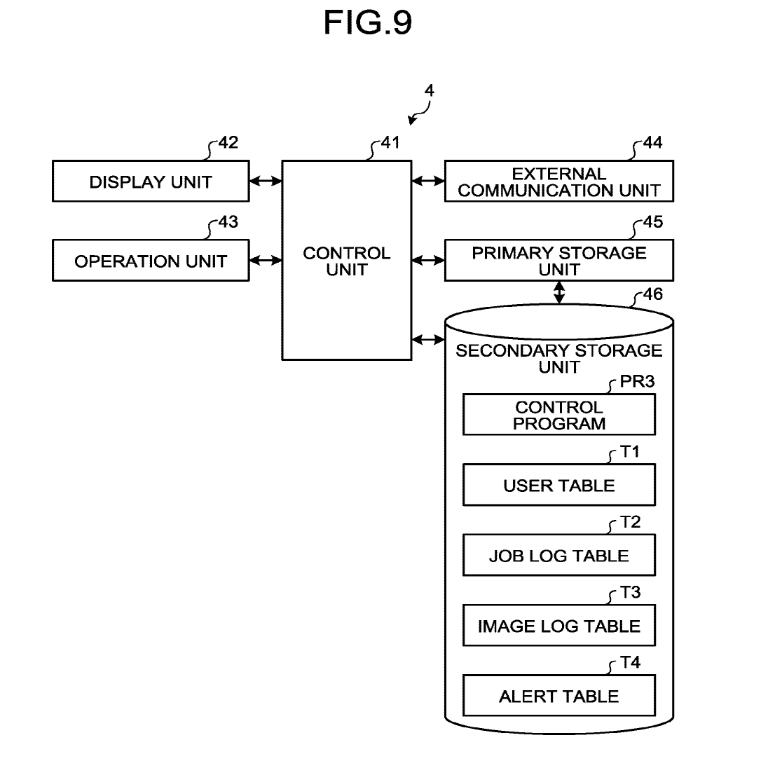

Next, a hardware configuration of the server device 4 will be explained. FIG. 9 is a block diagram of an example of a hardware configuration of the server device 4.

The server device 4 is provided with a control unit 41, a display unit 42, an operation unit 43, an external communication unit 44, a primary storage unit 45, and a secondary storage unit 46. The control unit 41 is a computing device such as a CPU that controls an entire operation of the server device 4.

The display unit 42 is a liquid crystal display device (LCD), for example. The display unit 42 displays a screen that provides an alert to the fact that a collection of an output material output by a user who uses the server device 4 is neglected and the like.

The operation unit 43 is an operation device such as a keyset and a mouse. The operation unit 43 receives various kinds of inputs depending on operations by a user.

The external communication unit 44 is a communication interface for connection to various kinds of devices via the network 5.

The primary storage unit 45 is a volatile memory, for example. The primary storage unit 45 is a storage area that functions as a work area in which data of various kinds input, for example, is expanded and temporarily retains the expanded data of various kinds.

The secondary storage unit 46 is a non-volatile storage device such as an HDD and an SSD, for example. The secondary storage unit 46 stores a control program PR3, a user table T1, a job log table T2, an image log table T3, and an alert table T4. The control program PR3 is software that enables fulfilling the functions included in the MFP 2.

The user table T1 stores the same information as the user table T1 stored in the secondary storage unit 19 of the MFP 2. Here, it is only necessary that the user table T1 is stored in at least one of the server device 4 and the MFP 2.

The job log table T2, the image log table T3, and the alert table T4 have the same data structures as the job log table T2, the image log table T3, and the alert table T4 stored in the secondary storage unit 19 of the MFP 2. A job log, an image log, and an alert content are recorded in one of the server device 4 and the MFP 2 depending on the setting. Therefore, the secondary storage unit 46 stores the job log table T2, the image log table T3, and the alert table T4, similarly to the MFP 2.

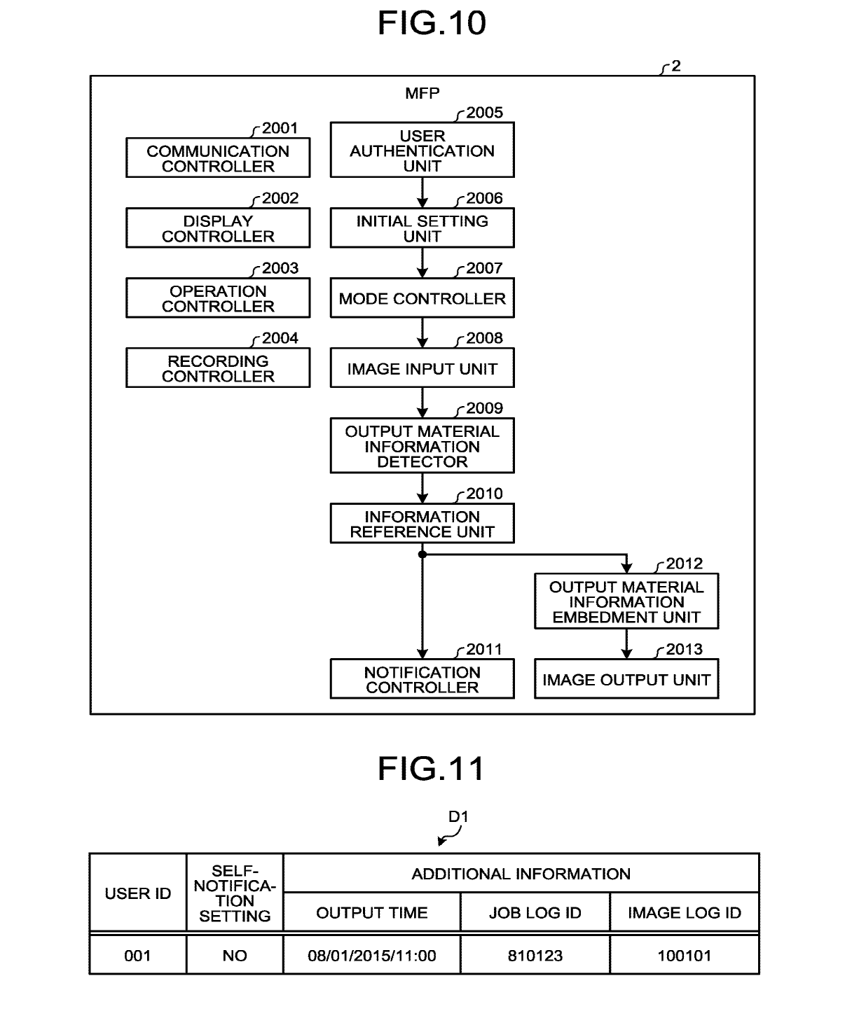

Next, characteristic functions included in each of the devices in the print system 1 will be explained. Here, FIG. 10 is a block diagram of an example of a functional block indicating a configuration of characteristic functions provided in the MFP 2 according to the embodiment. While functions according to the embodiment are mainly exemplified in FIG. 10 for the convenience of explanation, the functions included in the MFP 2 are not limited thereto.

The control unit 11 of the MFP 2 executes the control program PR1 and the like stored in the secondary storage unit 19 to realize various kinds of functions. Specifically, the control unit 11 realizes a communication controller 2001, a display controller 2002, an operation controller 2003, a recording controller 2004, a user authentication unit 2005, an initial setting unit 2006, a mode controller 2007, an image input unit 2008, an output material information detector 2009, an information reference unit 2010, a notification controller 2011, an output material information embedment unit 2012, and an image output unit 2013.

The communication controller 2001 controls the external communication unit 17 to communicate with the information processing device 3 and the server device 4 connected to the network 5.

The display controller 2002 controls the operation panel 12 to display various kinds of screens.

The operation controller 2003 controls the operation panel 12 to receive various kinds of inputs by an input person such as a user. Specifically, the operation controller 2003, which may be referred to as a first input controller, receives, from the operation panel 12, an operational input concerning a request for outputting image data. Not applying only to the operation panel 12, the operation controller 2003 may receive the operation concerning the request for outputting image data via the communication controller 2001. For example, the operation controller 2003 receives a command of requesting for outputting, by printing, image data and the like from the information processing device 3 via the communication controller 2001.

The recording controller 2004 records a log. More specifically, the recording controller 2004 records a job log, an image log, an output time, and an alert content. The recording controller 2004 records logs in one of the MFP 2, the server device 4, and both of the MFP 2 and the server device 4 based on a setting about a recording destination.

The user authentication unit 2005 executes a user authentication based on the user ID input via the card reader 15. Specifically, the user authentication unit 2005 as an identification unit identifies the user ID input via the card reader 15 as anyone among users registered in the user table T1. When the user ID is identified as a user, the user authentication unit 2005 authenticates the user. Besides, the user authentication unit 2005 determines whether or not the user of the input user ID is an administrator having an administrator privilege based on the user table T1. Not applying only to the card reader 15, the user authentication unit 2005 may execute the user authentication based on the user ID input via the operation panel 12 and the like.

The initial setting unit 2006 performs an initial setting based on the content input in the screen for various kinds of settings. For the initial setting, there are an administrator initial setting performed by an administrator having the administrator privilege and an initial setting performed by a user not having the administrator privilege.

The administrator initial setting includes an embedment log administration setting, a detection log administration setting, an output material information addition setting, and a detection time output setting. More specifically, the initial setting unit 2006 makes an embedment log administration setting concerning a record of a log and a notification to the administrator in embedding output material information D1 (see FIG. 11) in image data. The initial setting unit 2006 makes a detection log administration setting concerning a record of a log and a notification to the administrator when the output material information D1 is detected from the output material. The initial setting unit 2006 makes an output material information addition setting concerning additional information to be added to the output material information D1 to be embedded onto the image data, and this setting unit may be referred to a second setting controller. The initial setting unit 2006 makes a detection time output setting concerning a restriction of an output of the image data to which the output material information D1 is embedded, and this setting unit may be referred to a third setting controller. The detection time output setting includes a self-notification setting in which whether or not to display a name of the user ID of the output material information D1 on the operation panel 12 when the output material information D1 embedded onto the image data is detected is set. The initial setting unit 2006 makes the self-notification setting, and this setting unit may be referred to a fourth setting controller. When no self-notification is set, the MFP 2 does not display the name of the user ID of the output material information D1 on the operation panel 12. Therefore, since the person who finds the output material is not able to know what user has output the output material, it is possible to prevent individual information of the user who has output the output material from leaking out.

For the initial setting, there are an embedment administration setting and a detection time output setting. The initial setting unit 2006 makes an embedment administration setting concerning an embedment of the output material information D1 (see FIG. 11) of the image data. For the detection time output setting, the initial setting unit 2006 makes a restriction setting by which an output of the image data when the output material information D1 of the user is detected is restricted and a self-notification setting by which the fact that the output material information D1 is detected is displayed on the operation panel 12. The initial setting unit 2006 logs in to a predetermined SNS when the initial setting is finished.

The mode controller 2007 sets a mode to be executed by the MFP 2 based on a content input in a screen for function selection G10 (see FIG. 26). More specifically, the mode controller 2007, which may be referred to as a first setting controller, makes a setting to an output material information detection mode in which the output material information D1 (see FIG. 11) embedded onto the image data is detected based on the content input in the screen for function selection G10. The setting to the output material information detection mode enables the MFP 2 to execute an output material information detecting processing, which will be explained later, with respect to target image data.

The image input unit 2008, which may be referred to as a second input controller, receives an input of image data. More specifically, the image input unit 2008 receives an input of image data via the scanner 13. Alternatively, the image input unit 2008 receives an input of image data via the external communication unit 17.

The output material information detector 2009 as a detection unit detects the output material information D1 (see FIG. 11) from the image data. Here, the output material information D1 is used for identifying a user as a person who performs an operational input concerning a request for outputting the output material.

FIG. 11 is an explanatory view of a data structure of the output material information D1. The output material information D1 includes a user ID, a self-notification setting, and additional information. The user ID is identifying information for identifying a user who performs an operation concerning the request for outputting the image data with respect to the MFP 2. The self-notification setting is a setting about whether or not the name of the user of the user ID of the output material information D1 is displayed on the operation panel 12 of the MFP 2 having detected the output material information D1. For the additional information, what is added by the administrator of the MFP 2 is set. More specifically, the additional information includes an output time, a job log ID, and an image log ID. The output time is a time when the image data is output. The job log ID is identifying information for identifying a log of a job concerning the output of the image data. The image log ID is identifying information for identifying an image log of the image data output.

With reference to FIG. 10 again, the information reference unit 2010 refers to various kinds of tables. In other words, the information reference unit 2010 refers to the user table T1, the job log table T2, the image log table T3, and the alert table T4 which are stored in the secondary storage unit 19 of the MFP 2. Alternatively, the information reference unit 2010 refers to the user table T1, the job log table T2, the image log table T3, and the alert table T4 which are stored in the secondary storage unit 46 of the server device 4.

The notification controller 2011 as a notification unit notifies the fact that the image data is detected in a manner recognizable by the user of the user ID of the output material information D1 when the output material information D1 is detected from the image data. The notification controller 2011 provides the notification when the user ID of the user who uses the MFP 2 discords with the user ID of the detected output material information D1. On the other hand, the notification controller 2011 does not provide the notification when the user ID of the user who uses the MFP 2 does not discord with the user ID of the detected output material information D1 since the situation does not apply to the neglect of collection of the output material. It is therefore possible to prevent an unnecessary notification to the user who has output the output material.

The notification controller 2011 performs the notification by at least one of a mail, an SNS, and the operation panel 12 based on the notification setting. In other words, the notification controller 2011 notifies the information processing device 3 used by the user of a message by a mail or an SNS. It is thus possible in the MFP 2 to provide the notification to the user even when the user neglects the collection of the output material and returns to his/her own seat. Besides it is possible by a notification displayed on the operation panel 12 in the MFP 2 to perform the notification to the user even when it is not possible to provide the notification by a mail or an SNS. On this occasion, the notification controller 2011 provides the notification to the user of the user ID of the output material information D1 and the administrator of the MFP 2. The user then confirms the presence/absence of the neglect of the collection of the output material. The administrator is able to confirm that the user collects the output material. It is thus possible to prevent the output material from being collected by an unintended third party and the information from leaking out. Here, the notification by the notification controller 2011 to the administrator of the MFP 2 is just one example. The administrator may be an administrator of the system, an administrator of users, or an administrator who administers an output material whose collection is neglected.

The notification controller 2011 provides the notification together with additional information when the additional information is added in the output material information D1. It is possible for the user to confirm the neglect of the collection of the output material by taking the information included in the additional information into consideration.

The output material information embedment unit 2012 embeds the output material information D1 onto the image data based on the embedment log administration setting. The output material information embedment unit 2012 adds the additional information based on the output material information addition setting.

The image output unit 2013, which may be referred to an output controller, outputs image data. More specifically, the image output unit 2013 outputs image data by outputting via printing or transmission. The image output unit 2013 as an output unit then outputs the image data to which the output material information D1 is embedded when the output material information embedment unit 2012 embeds the output material information D1 onto the image data. In other words, the image output unit 2013 outputs the image data to which the output material information D1 to which the additional information is added when the output material information embedment unit 2012 embeds, onto the image data, the output material information D1 to which the additional information is added.

The image output unit 2013 restricts the image data depending on the restriction setting when the output material information detector 2009 detects the output material information D1. In other words, the image output unit 2013 outputs the image data without restriction when no restriction is set for the restriction setting. When a job stop is set for the restriction setting, the image output unit 2013 stops a job of outputting the image data. When a copy guard is set for the restriction setting, the image output unit 2013 outputs image data to which a copy guard is given. It is thus possible in the MFP 2 to prevent information leakage since copying and the like can be prohibited as for a highly confidential output material.

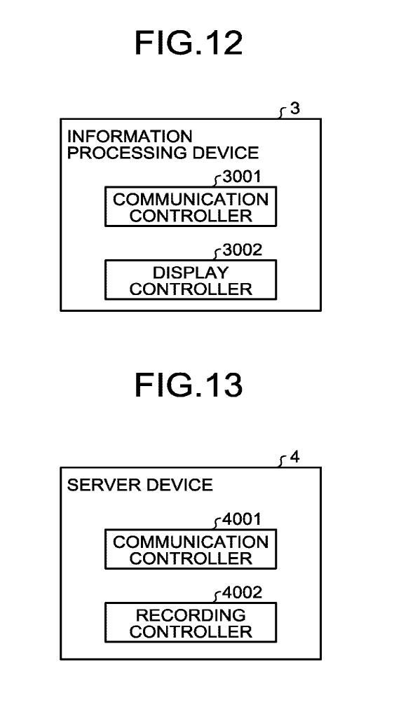

Here, FIG. 12 is a block diagram of an example of a functional block indicating a configuration of characteristic functions provided in the information processing device 3 according to the embodiment. While functions according to the embodiment are mainly exemplified in FIG. 12 for the convenience of explanation, the functions included in the information processing device 3 are not limited thereto.

The control unit 31 of the information processing device 3 executes the control program PR2 and the like stored in the secondary storage unit 36 to realize various kinds of functions. Specifically, the control unit 31 realizes a communication controller 3001 and a display controller 3002.

The communication controller 3001 controls the external communication unit 34 to communicate with the MFP 2 and the server device 4 connected to the network 5.

The display controller 3002 controls the display unit 32 to display various kinds of screens. For example, the display controller 3002 displays a screen concerning a mail function and a screen concerning an SNS function.

Here, FIG. 13 is a block diagram of an example of a functional block indicating a configuration of characteristic functions provided in the server device 4 according to the embodiment. While functions according to the embodiment are mainly exemplified in FIG. 13 for the convenience of explanation, the functions included in the server device 4 are not limited thereto.

The control unit 41 of the server device 4 executes the control program PR3 and the like stored in the secondary storage unit 46 to realize various kinds of functions. Specifically, the control unit 41 realizes a communication controller 4001 and a recording controller 4002.

The communication controller 4001 controls the external communication unit 44 to communicate with the MFP 2 and the information processing device 3 connected to the network 5.

The recording controller 4002 records a log. More specifically, the recording controller 4002 records a job log, an image log, an output time, and an alert content. In other words, the recording controller 4002 controls writing to and reading from the user table T1, the job log table T2, the image log table T3, and the alert table T4 which are stored in the secondary storage unit 46.

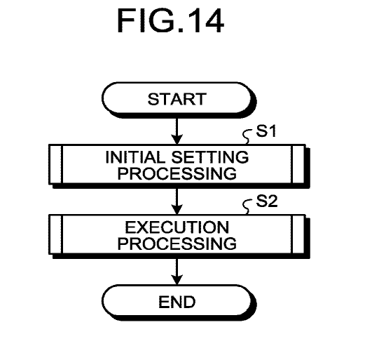

Next, an example of the operation of the MFP 2 according to the embodiment will be explained. Here, FIG. 14 is a flowchart of an example of an operation of the MFP 2 according to the embodiment.

First, the MFP 2 receives the initial setting by the administrator of the MFP 2 and the user of the MFP 2 in an initial setting processing to be explained later (step S1). The administrator of the MFP 2 sets a setting item to be set in common with all users who use the MFP 2. The user of the MFP 2 sets a personal setting item of the MFP 2.

Next, the MFP 2 executes the functions included in the MFP 2 in an execution processing to be explained later (step S2).

Various kinds of processes of the MFP 2 will be explained more specifically below.

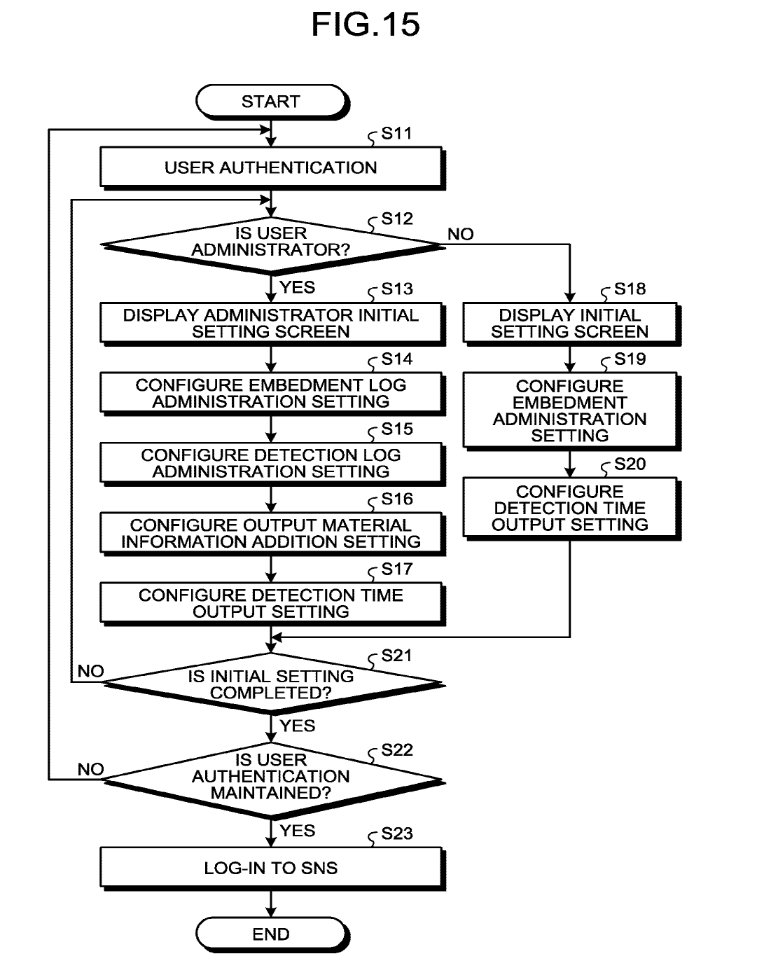

FIG. 15 is a flowchart of an example of the initial setting processing to be executed by the MFP 2 according to the embodiment.

The user authentication unit 2005 of the MFP 2 executes the user authentication based on the user ID input via the card reader 15 (step S11). Next, the user authentication unit 2005 of the MFP 2 determines whether or not the authenticated user is the administrator (step S12).

When the authenticated user is the administrator (“Yes” at step S12), the display controller 2002 of the MFP 2 displays a screen for administrator initial setting G1 on the operation panel 12 (step S13).

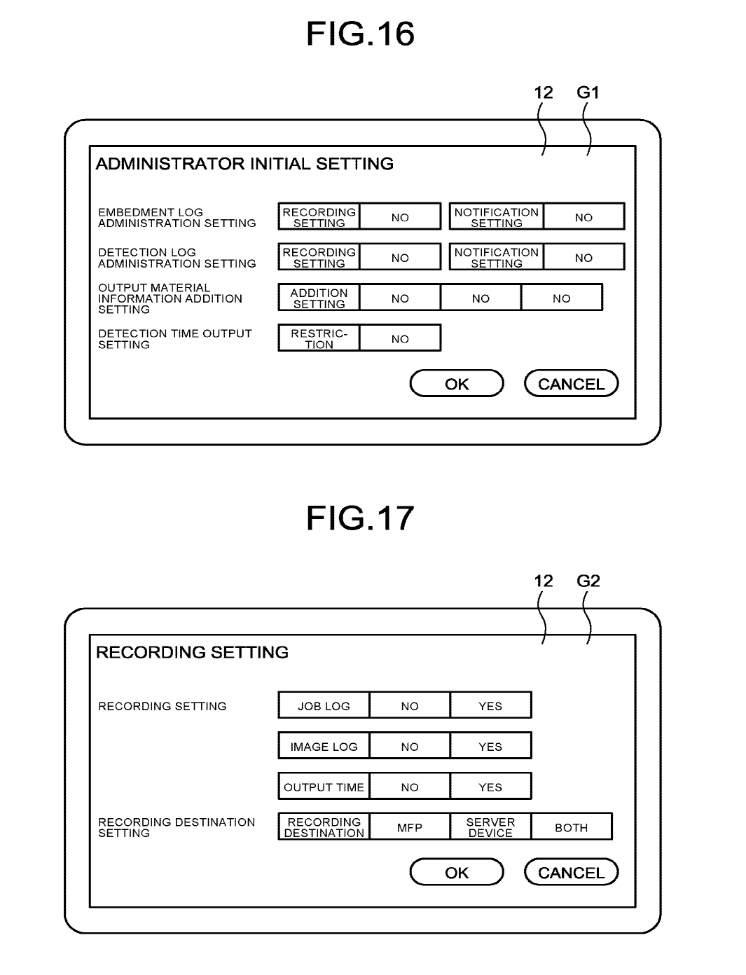

Here, FIG. 16 is an explanatory view of an example of the screen for administrator initial setting G1. The screen for administrator initial setting G1 displays a setting concerning an embedment of the output material information D1 of the administrator. In the screen for administrator initial setting G1, settings including the embedment log administration setting, the detection log administration setting, the output material information addition setting, and the detection time output setting are displayed. The embedment log administration setting is about a record of a log and a notification to the administrator in embedding the output material information D1 onto the image data. Besides, the embedment log administration setting includes a recording setting concerning a log recording and a notification setting concerning a notification to the effect that the output material information D1 is embedded. The detection log administration setting is about a record of a log and a notification to the administrator in detecting the output material information D1 from the output material. Besides, the detection log administration setting includes a recording setting concerning a log recording and a notification setting concerning a notification to the effect that the output material information D1 is detected. The output material information addition setting is about additional information to be added to the output material information D1 to be embedded onto the image data. The detection time output setting is about a restriction of an output of the image data to which the output material information D1 is embedded. The operation panel 12 receives an input of changing the settings including the embedment log administration setting, the detection log administration setting, the output material information addition setting, and the detection time output setting in the screen for administrator initial setting G1.

The display controller 2002 displays a screen for recording setting G2 when receiving an input of changing the recording settings for the embedment log administration setting and the detection log administration setting in the screen for administrator initial setting G1. Here, FIG. 17 is an explanatory view of an example of the screen for recording setting G2. The screen for recording setting G2 is a screen on which settings concerning a record of various kinds of logs are input. The screen for recording setting G2 receives an input about whether or not to record each of the job log, the image log, and the output time. Besides, the screen for recording setting G2 receives an input of selecting, as a destination of a log recording, one of the MFP 2, the server device 4, and both of the MFP 2 and the server device 4.

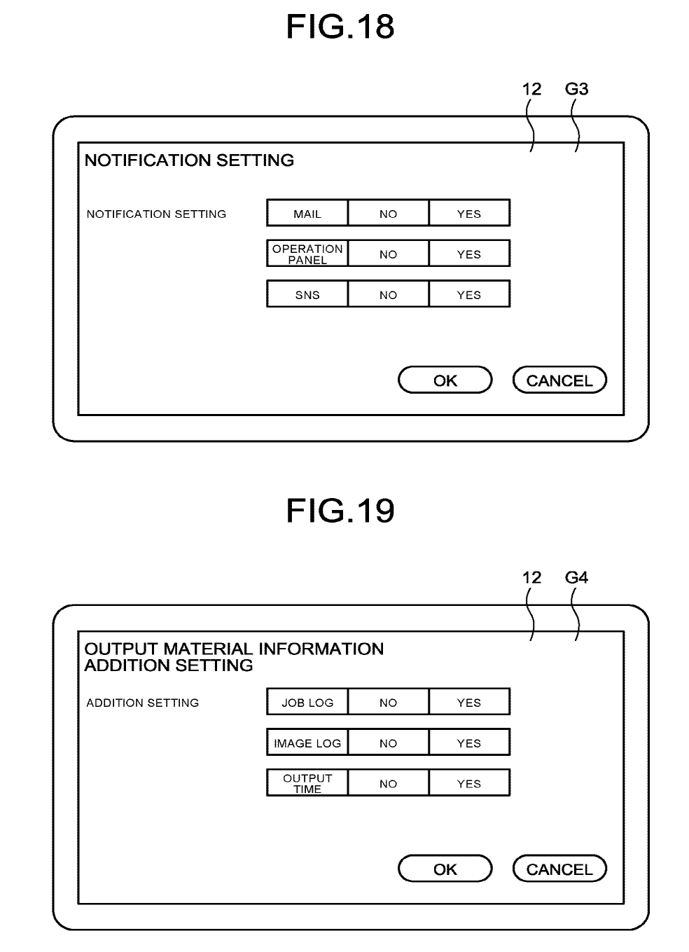

The display controller 2002 displays a screen for notification setting G3 when receiving an input of changing the notification settings for the embedment log administration setting and the detection log administration setting in the screen for administrator initial setting G1. Here, FIG. 18 is an explanatory view of an example of the screen for notification setting G3. The screen for notification setting G3 is a screen on which settings concerning a notification method are input. The screen for notification setting G3 receives an input about whether or not to make a notification as for each of notification methods, i.e., the mail, the operation panel 12, and the SNS.

The display controller 2002 displays a screen for output material information addition setting G4 when receiving an input of changing the output material information addition setting in the screen for administrator initial setting G1. Here, FIG. 19 is an explanatory view of an example of the screen for output material information addition setting G4. The screen for output material information addition setting G4 is a screen on which information to be added to the output material information D1 is set. The screen for output material information addition setting G4 receives an input about whether or not to add each of the job log, the image log, and the output time to the output material information D1.

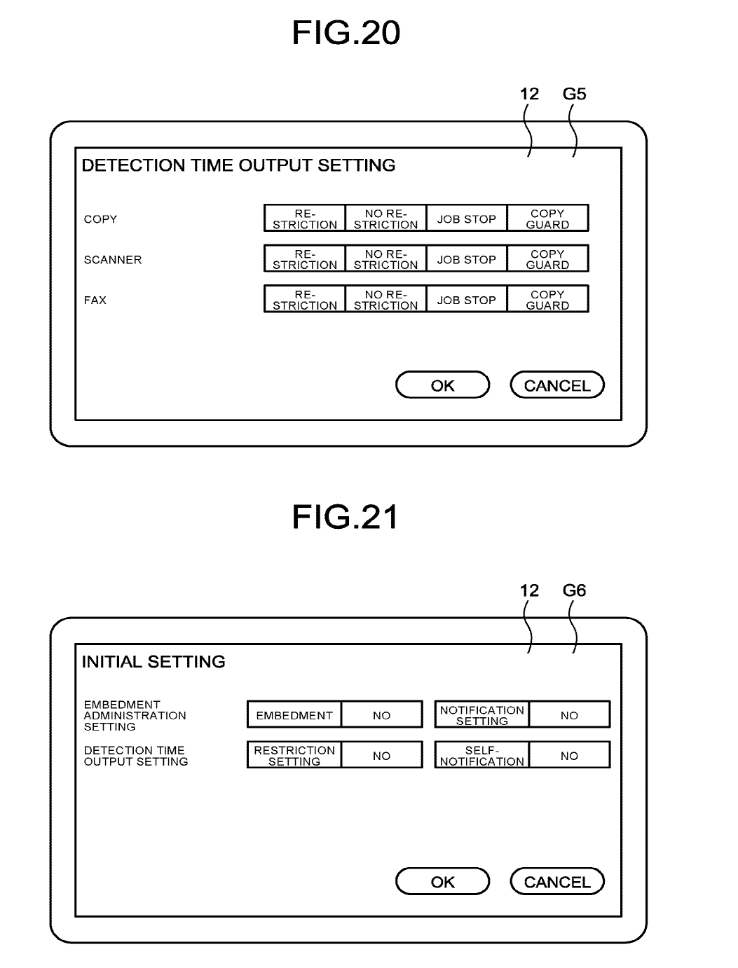

The display controller 2002 displays a screen for detection time output setting G5 when receiving an input of changing the detection time output setting in the screen for administrator initial setting G1. Here, FIG. 20 is an explanatory view of an example of the screen for detection time output setting G5. The screen for detection time output setting G5 is a screen on which a restriction of an output of image data is set when the output material information D1 embedded onto the image data is detected. The screen for detection time output setting G5 receives a restriction setting by which an output is restricted for each of output processes of the copy, the scanner, and the FAX. The restriction setting includes “NO RESTRICTION”, “JOB STOP”, and “COPY GUARD”. The “NO RESTRICTION” is a setting with no restriction in output. The “JOB STOP” is a setting in which a job concerning an output processing is stopped. The “COPY GUARD” is a setting in which a string of letters notifying the fact that copying is prohibited is added in output or image data is ruined with a single color such as gray color in output.

With reference to FIG. 15 again, the initial setting unit 2006 of the MFP 2 makes the embedment log administration setting based on the content input for the embedment log administration setting in the screen for recording setting G2 and the screen for notification setting G3 (step S14).

Next, the initial setting unit 2006 of the MFP 2 makes the detection log administration setting based on the content input for the detection log administration setting in the screen for recording setting G2 and the screen for notification setting G3 (step S15).

The initial setting unit 2006 of the MFP 2 then makes the output material information addition setting based on the content input in the screen for output material information addition setting G4 (step S16).

The initial setting unit 2006 of the MFP 2 then makes the detection time output setting based on the content input in the screen for detection time output setting G5 (step S17).

On the other hand, when the authenticated user is not the administrator (“No” at step S12), the display controller 2002 of the MFP 2 displays a screen for initial setting G6 (step S18).

Here, FIG. 21 is an explanatory view of an example of the screen for initial setting G6. The screen for initial setting G6 displays a setting concerning the embedment of the output material information D1 of the user. The screen for initial setting G6 makes a display about settings including an embedment administration setting and a detection time output setting. The embedment administration setting is about the embedment of the output material information D1 of the image data. Besides, the embedment administration setting includes an embedment setting concerning the embedment of the output material information D1 and a notification setting concerning a notification to the effect that the embedded output material information D1 is detected. The detection time output setting is about an output of the image data to which the output material information D1 is embedded. Besides, the detection time output setting includes a restriction setting by which an output of image data when the output material information D1 of the user is detected is restricted and a self-notification setting by which the fact that the output material information D1 is detected is displayed on the operation panel 12.

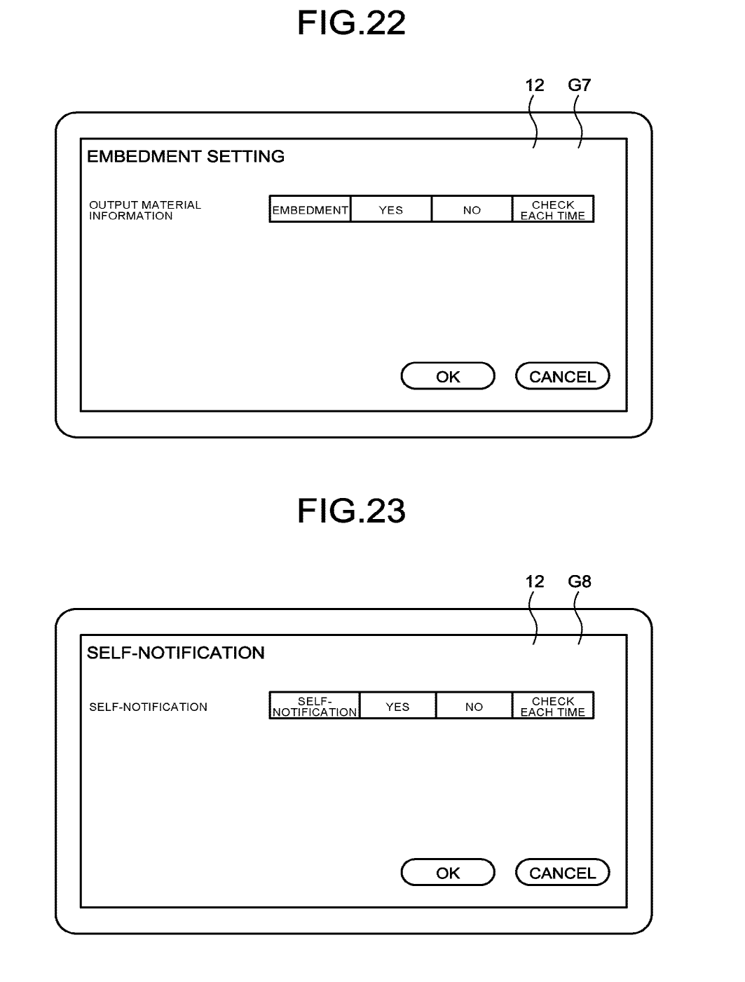

The display controller 2002 displays a screen for embedment setting G7 when receiving an input of changing the embedment setting in the screen for initial setting G6. Here, FIG. 22 is an explanatory view of an example of the screen for embedment setting G7. The screen for embedment setting G7 is a screen on which the embedment of the output material information D1 onto the image data is set. The screen for embedment setting G7 receives an input of selecting one of “YES” for embedment of the output material information D1, “NO” for embedment of the output material information D1, and “CHECK EACH TIME” in embedding the output material information D1.

The display controller 2002 displays the screen for notification setting G3 when receiving an input of changing the notification setting in the screen for initial setting G6. The display controller 2002 displays the screen for detection time output setting G5 when receiving an input of changing the restriction setting in the screen for initial setting G6.

The display controller 2002 displays a screen for self-notification G8 when receiving an input of changing the self-notification setting in the screen for initial setting G6. Here, Here, FIG. 23 is an explanatory view of an example of the screen for self-notification G8. The screen for self-notification G8 is a screen on which a self-notification when the output material information D1 is detected from the image data is set. The screen for self-notification G8 receives an input of selecting one of “YES” for self-notification, “NO” for self-notification, and “CHECK EACH TIME” in embedding the output material information D1. When “YES” for self-notification is set, the display controller 2002 displays a name of an output user related to the output material information D1 in a detection result screen G12 (see FIG. 29) of the output material information detection mode. On the other hand, when “NO” for self-notification is set, the display controller 2002 does not cause the name of the output user related to the output material information D1 to be displayed in the detection result screen G12 (see FIG. 29) of the output material information detection mode.

With reference to FIG. 15 again, the initial setting unit 2006 of the MFP 2 makes the embedment administration setting based on the content input for the embedment administration setting in the screen for embedment setting G7 and the screen for notification setting G3 (step S19).

Next, the initial setting unit 2006 of the MFP 2 makes the detection time output setting based on the content input for the detection time output setting in the screen for detection time output setting G5 and the screen for self-notification G8 (step S20).

The initial setting unit 2006 of the MFP 2 then determines whether or not the initial setting is completed (step S21). When the initial setting is not completed (“No” at step S21), the initial setting unit 2006 of the MFP 2 moves to step S12 and continues the initial setting.

On the other hand, when the initial setting is completed (“Yes” at step S21), the initial setting unit 2006 of the MFP 2 determines whether or not the user authentication is maintained (step S22). When the user authentication is not maintained (“No” at step S22), the initial setting unit 2006 of the MFP 2 moves to step S11 and asks for user authentication.

On the other hand, when the user authentication is maintained (“Yes” at step S22), the initial setting unit 2006 of the MFP 2 logs in to an SNS (step S23).

The MFP 2 ends the initial setting processing in the above explained manner.

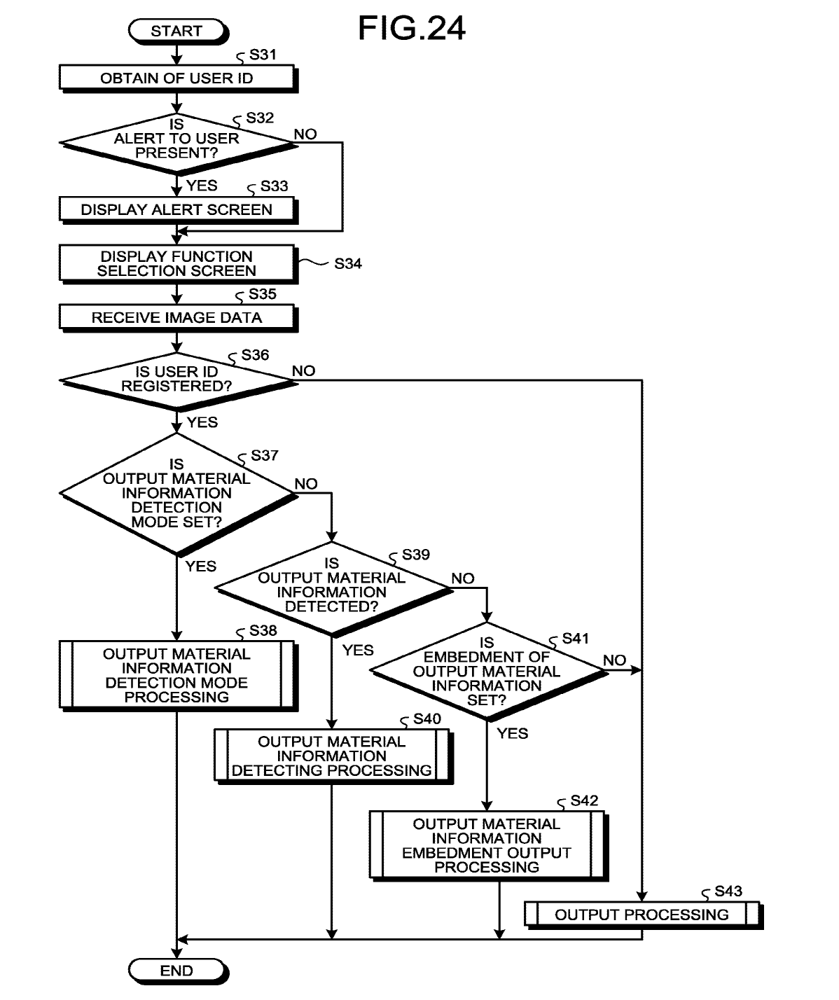

FIG. 24 is a flowchart of an example of the execution processing to be executed by the MFP 2 according to the embodiment.

The user authentication unit 2005 of the MFP 2 obtains a user ID of the user authenticated in the initial setting (step S31).

Next, the notification controller 2011 of the MFP 2 determines whether or not an alert to be notified to the user of the user ID is present (step S32). In other words, the notification controller 2011 determines whether or not the alert content to be notified to the user of the user ID is registered in the alert table T4.

When the alert to be notified to the user is not present (“No” at step S32), the display controller 2002 of the MFP 2 moves to step S34. On the other hand, when the alert to be notified to the user is present (“Yes” at step S32), the display controller 2002 of the MFP 2 displays an alert screen G9 (step S33).

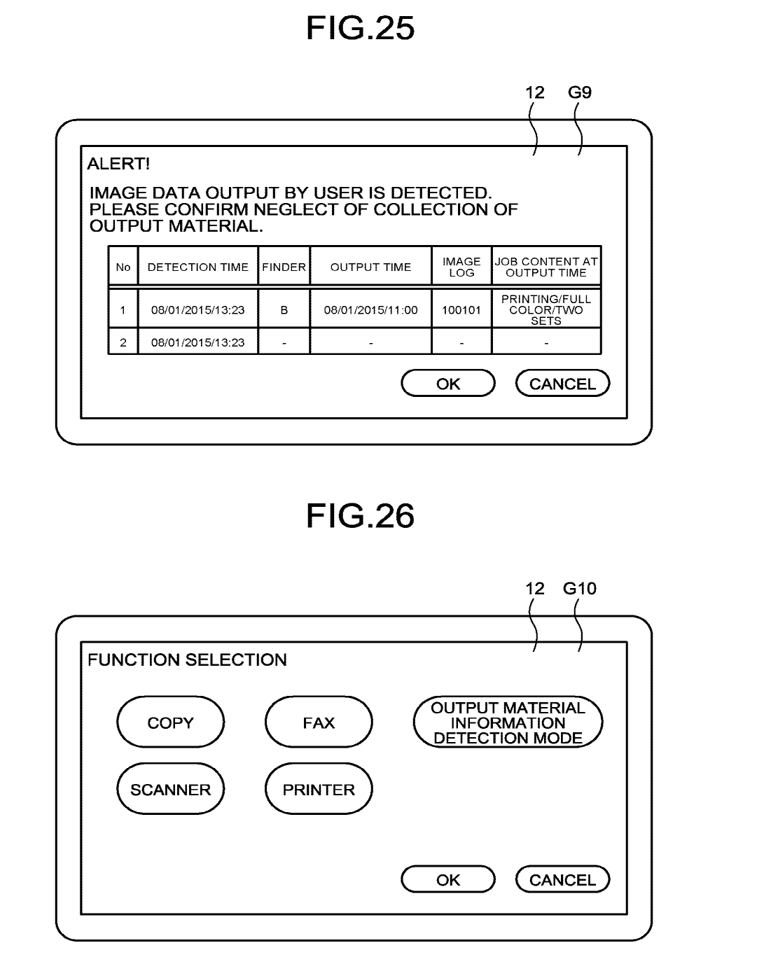

Here, FIG. 25 is an explanatory view of an example of the alert screen G9. The alert screen G9 is a screen which provides an alert to the effect of the neglect of the collection of the output material in response to the detection of the image data output by the user. In the alert screen G9, a detection time, a finder, an output time, an image log, and a job content at output time are displayed. The finder is displayed when the notification of the name is accepted by the user who has found the output material in a screen for finder notification setting G11, which will be explained later. The output time, the image log, and the job content at output time are displayed when addition thereof to the output material information D1 is set in the output material information addition setting.

Next, the display controller 2002 of the MFP 2 displays the screen for function selection G10 on which a function to be executed by the MFP 2 is selected (step S34).

Here, FIG. 26 is an explanatory view of an example of the screen for function selection G10. The screen for function selection G10 is a screen on which a function to be executed by the MFP 2 is selected. The screen for function selection G10 allows selecting a function to be executed by the MFP 2 among the copy, the FAX, the output material information detection mode, the scanner, and the printer. Besides, any functions other than the above may be displayed in the screen for function selection G10.

Next, the image input unit 2008 of the MFP 2 receives an input of image data as a target of the processing by the MFP 2 (step S35).

The user authentication unit 2005 of the MFP 2 then determines whether or not the obtained user ID is registered in the user table T1 (step S36). In other words, the user authentication unit 2005 determines whether or not the user of the user ID is an administration target. Here, the user authentication unit 2005 determines that the user is not the administration target when the user ID is what is lent to a guest user and the like even in the case where the obtained user ID is registered in the user table T1.

When the user ID is not registered in the user table T1 (“No” at step S36), the MFP 2 moves to step S43.

When the user ID is registered in the user table T1 (“Yes” at step S36), the mode controller 2007 of the MFP 2 determines whether or not the output material information detection mode is set (step S37). When the output material information detection mode is set (“Yes” at step S37), the MFP 2 executes an output material information detection mode processing, which will be explained later (step S38).

On the other hand, when the output material information detection mode is not set (“No” at step S37), the output material information detector 2009 of the MFP 2 determines whether or not the output material information D1 is detected from the input image data (step S39). When the output material information D1 is detected from the input image data (“Yes” at step S39), the MFP 2 executes an output material information detecting processing, which will be explained later (step S40).

On the other hand, when the output material information D1 is not detected from the input image data (“No” at step S39), the output material information embedment unit 2012 of the MFP 2 determines whether or not the embedment of the output material information D1 is set (step S41). When the embedment of the output material information D1 is set (“Yes” at step S41), the MFP 2 executes an output material information embedment output processing, which will be explained later (step S42).

On the other hand, when the embedment of the output material information D1 is not set (“No” at step S41), the MFP 2 executes an output processing, which will be explained later (step S43).

In the manner above, the MFP 2 ends the execution processing.

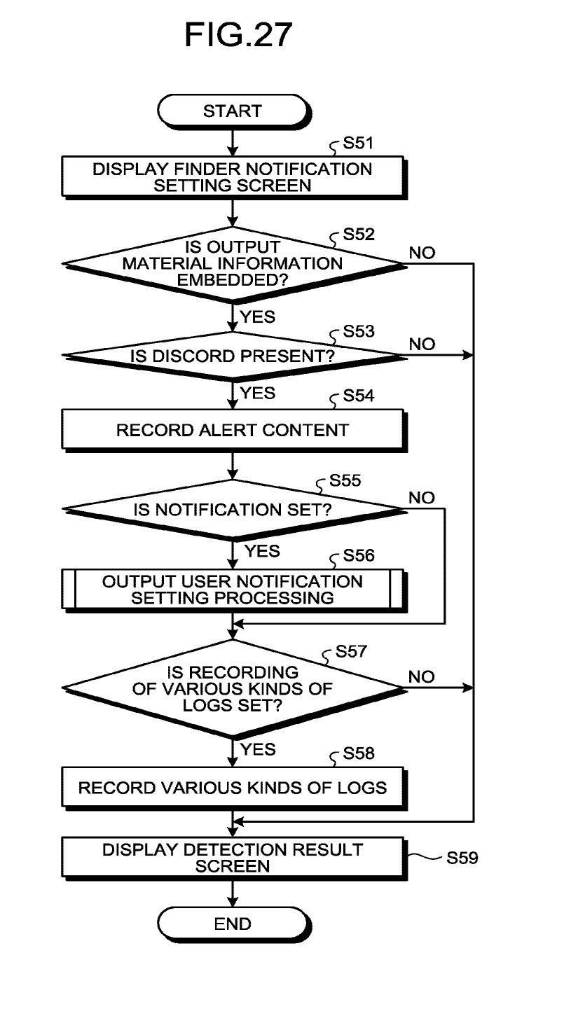

FIG. 27 is a flowchart of an example of the output material information detection mode processing to be executed by the MFP 2 according to the embodiment.

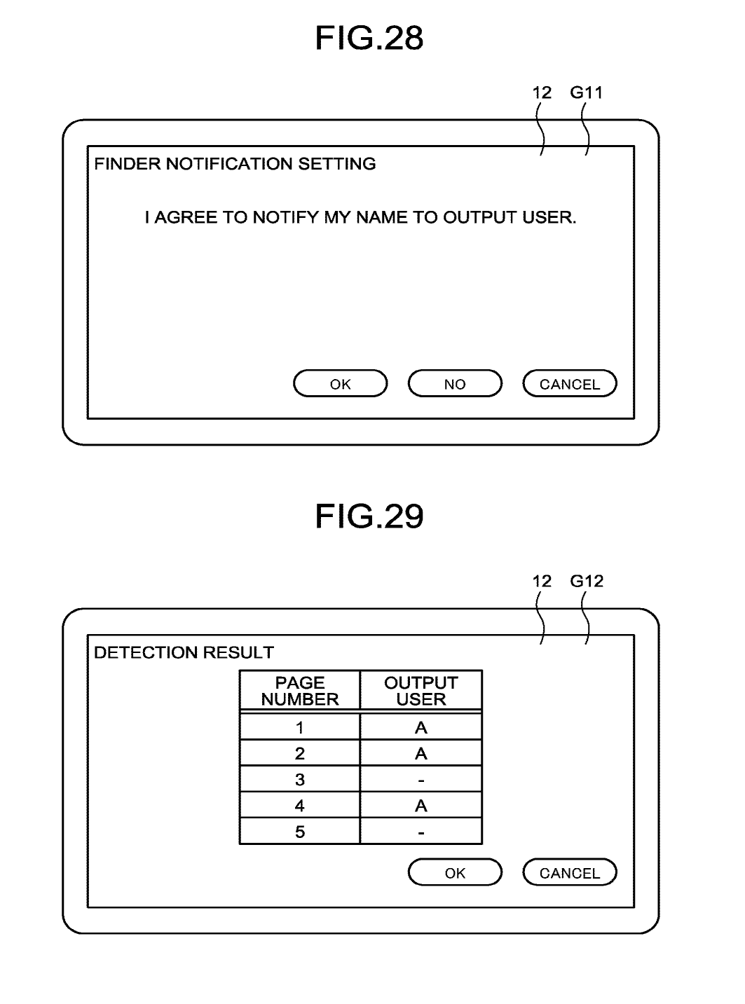

The display controller 2002 of the MFP 2 displays the screen for finder notification setting G11 (step S51). Here, FIG. 28 is an explanatory view of an example of the screen for finder notification setting G11. The screen for finder notification setting G11 is a screen on which whether or not to accept the notification, to the user who has output the output material, of the name in the alert screen G9 is set.

Next, the output material information detector 2009 of the MFP 2 determines whether or not the output material information D1 is embedded onto the input image data (step S52). When the output material information D1 is not embedded (“No” at step S52), the MFP 2 moves to step S59.

On the other hand, when the output material information D1 is embedded (“Yes” at step S52), the notification controller 2011 of the MFP 2 determines whether or not the user ID of the user who uses the MFP 2 discords with the user ID of the detected output material information D1 (step S53).

When user ID of the user who uses the MFP 2 does not discord with the user ID of the detected output material information D1 (“No” at step S53), the MFP 2 moves to step S59.

On the other hand, when the user ID of the user who uses the MFP 2 discords with the user ID of the detected output material information D1 (“Yes” at step S53), the recording controller 2004 of the MFP 2 records the alert content in the alert table T4 based on the detection log administration setting (step S54).

Next, the notification controller 2011 of the MFP 2 determines whether or not notification is set in the notification setting for the embedment administration setting (step S55). When the notification is not set (“No” at step S55), the MFP 2 moves to step S57.

On the other hand, when the notification is set (“Yes” at step S55), the MFP 2 executes an output user notification setting processing, which will be explained later (step S56).

Next, the recording controller 2004 of the MFP 2 determines whether or not recording of various kinds of logs is set for the detection log administration setting (step S57). When recording of various kinds of logs is not set (“No” at step S57), the MFP 2 moves to step S59.

On the other hand, when recording of various kinds of logs is set (“Yes” at step S57), the recording controller 2004 of the MFP 2 records a corresponding log (step S58). In other words, the recording controller 2004 records the image data as an image log in the image log table T3 based on the detection log administration setting. The recording controller 2004 records a job log in the job log table T2 based on the detection log administration setting.

Next, the display controller 2002 of the MFP 2 displays the detection result screen G12 (step S59).

Here, FIG. 29 is an explanatory view of an example of the detection result screen G12. The detection result screen G12 is a screen on which a detection result of the output material information detection mode is displayed. In the detection result screen G12, a detection result of the processing of the output material information detection mode is displayed for each page of the output material as a processing target of the output material information detection mode. In other words, the detection result screen G12 displays the name of the user of the user ID of the output material information D1 embedded onto the output material for each page of the output material as the processing target of the output material information detection mode. The display controller 2002 displays the name of the output user in the detection result screen G12 when “YES” is set for the self-notification in the screen for self-notification G8. The display controller 2002 then does not cause the name of the output user to be displayed when the “NO” is set for the self-notification in the screen for self-notification G8 or when the output material information D1 is not detected from the output material.

In the manner explained above, the MFP 2 ends the output material information detection mode processing.

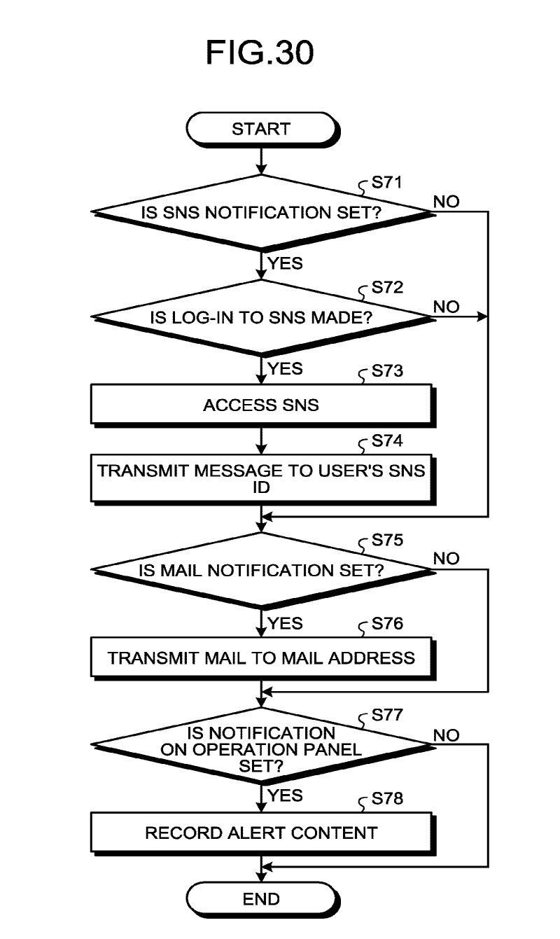

FIG. 30 is a flowchart of an example of the output user notification setting processing to be executed by the MFP 2 according to the embodiment.

The notification controller 2011 of the MFP 2 determines whether or not notification to the SNS is set in the notification setting for the embedment administration setting (step S71). When the notification to the SNS is not set (“No” at step S71), the MFP 2 moves to step S75.

When the notification to the SNS is set (“Yes” at step S71), the notification controller 2011 of the MFP 2 determines whether or not log-in to the SNS that the output user belongs to is already done (step S72). In other words, the notification controller 2011 determines whether or not log-in to the SNS associated with the user ID of the detected output material information D1 in the user table T1 is already done.

When log-in to the SNS is not done (“No” at step S72), the MFP 2 moves to step S75.

On the other hand, when log-in to the SNS is already done (“Yes” at step S72), the notification controller 2011 of the MFP 2 accesses the SNS (step S73). Next, the notification controller 2011 of the MFP 2 transmits a message to the user's SNS ID (step S74).

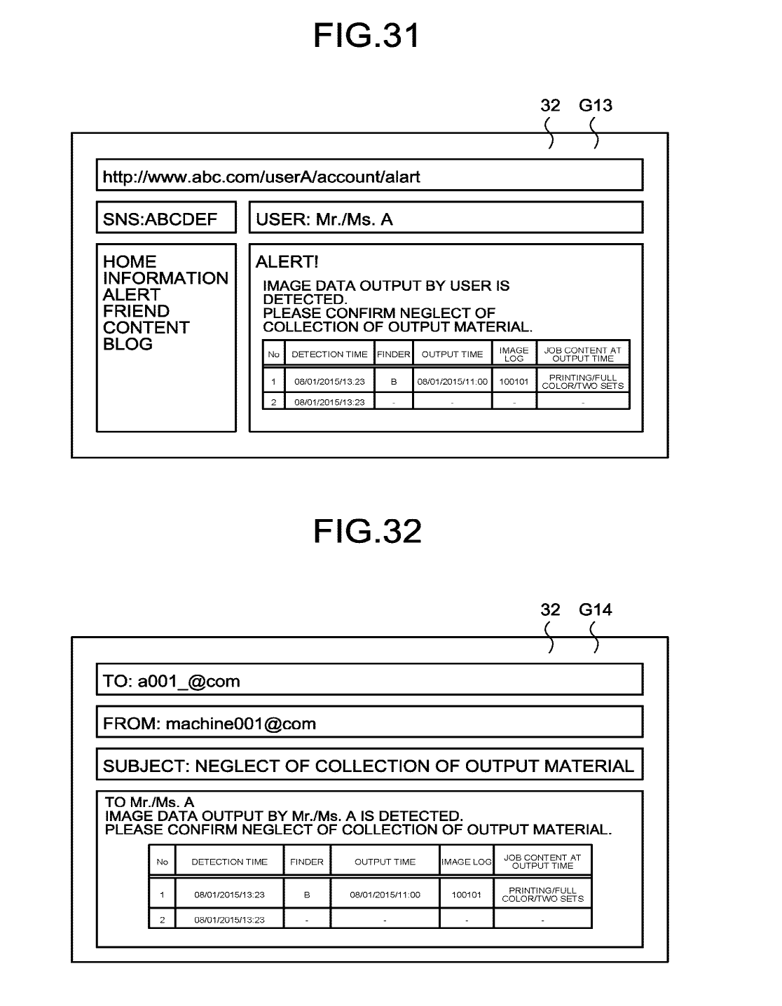

The display controller 3002 of the information processing device 3 then displays an SNS screen G13 in the display unit 32. Here, FIG. 31 is an explanatory view of an example of the SNS screen G13. The SNS screen G13 gives an alert about the neglect of the collection of the output material in response to the detection of the image data output by the user. In the SNS screen G13, a detection time, a finder, an output time, an image log, and a job content at output time are displayed, similarly to the alert screen G9.

Next, the notification controller 2011 of the MFP 2 determines whether or not notification by mail is set in the notification setting for the embedment administration setting (step S75). When the notification by mail is not set (“No” at step S75), the MFP 2 moves to step S77.

When the notification by mail is set (“Yes” at step S75), the notification controller 2011 of the MFP 2 transmits a mail to the mail address registered in the user table T1 (step S76).

The display controller 3002 of the information processing device 3 displays a mail screen G14 in the display unit 32. Here, FIG. 32 is an explanatory view of an example of the mail screen G14. The mail screen G14 gives the alert about the neglect of the collection of the output material in response to the detection of the image data output by the user. In the mail screen G14, the detection time, the finder, the output time, the image log, and the job content at output time are displayed, similarly to the alert screen G9.

Next, the notification controller 2011 of the MFP 2 determines whether or not a display on the operation panel 12 is set in the notification setting for the embedment administration setting (step S77). When the display on the operation panel 12 is not set (“No” at step S77), the MFP 2 ends the output user notification setting processing.

When the display on the operation panel 12 is set (“Yes” at step S77), the notification controller 2011 of the MFP 2 records the alert content in the alert table T4 (step S78). The display controller 2002 of the MFP 2 displays the alert screen G9.

In the manner explained above, the MFP 2 ends the output user notification setting processing.

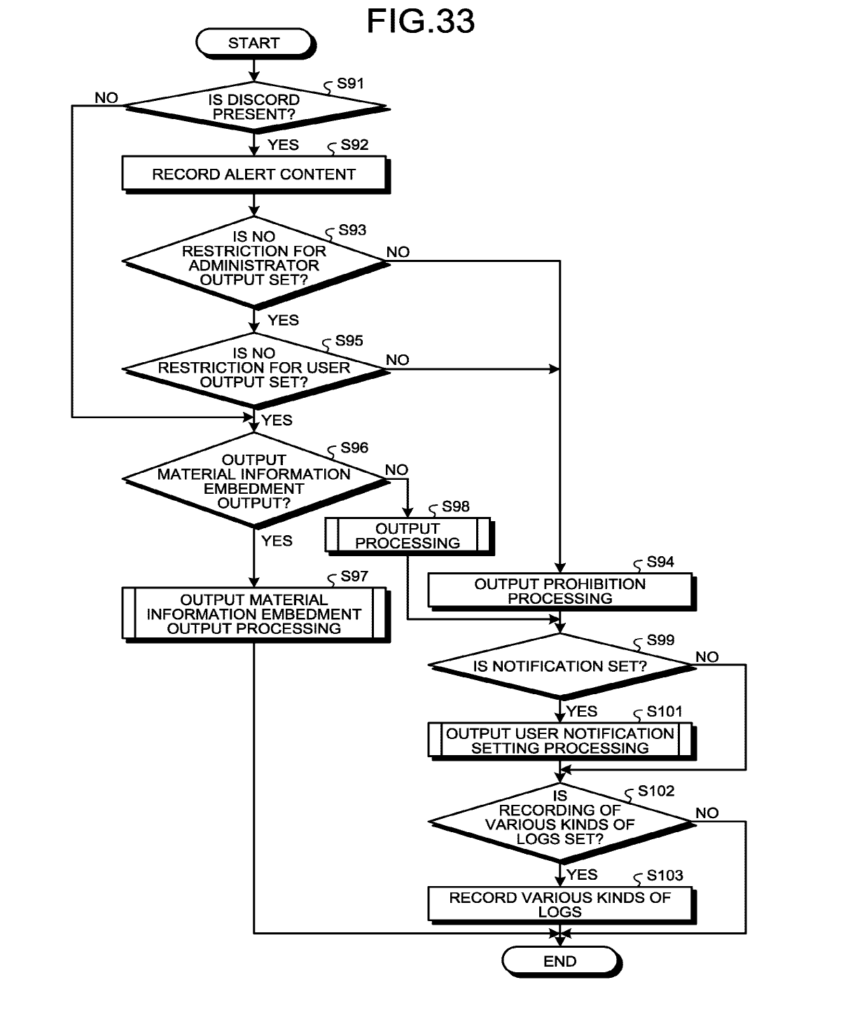

FIG. 33 is a flowchart of an example of the output material information detecting processing to be executed by the MFP 2 according to the embodiment.

The notification controller 2011 of the MFP 2 determines whether or not the user ID of the user who uses the MFP 2 discords with the user ID of the detected output material information D1 (step S91).

When the user ID of the user who uses the MFP 2 does not discord with the user ID of the detected output material information D1 (“No” at step S91), the MFP 2 moves to step S96.

On the other hand, when the user ID of the user who uses the MFP 2 discords with the user ID of the detected output material information D1 (“Yes” at step S91), the notification controller 2011 of the MFP 2 records the alert content in the alert table T4 based on the detection log administration setting (step S92).

Next, the image output unit 2013 of the MFP 2 determines whether or not no restriction is set for the output of image data in the administrator detection time output setting (step S93). When no restriction is not set for the output of the image data (“No” at step S93), the image output unit 2013 of the MFP 2 executes an output prohibition processing based on the restriction set for the detection time output setting (step S94). In other words, the image output unit 2013 stops a job of outputting the image data. Alternatively, the image output unit 2013 outputs image data to which a copy guard is provided.

On the other hand, when no restriction is set for the output of the image data (“Yes” at step S93), the image output unit 2013 of the MFP 2 determines whether or not no restriction for the output of image data is set in the user's detection time output setting (step S95). When no restriction is not set for the output of the image data (“No” at step S95), the image output unit 2013 of the MFP 2 moves to step S94.

On the other hand, when no restriction is set for the output of the image data (“Yes” at step S95), the image output unit 2013 of the MFP 2 determines whether or not it is an output processing of embedding the output material information D1 (step S96). When it is the output processing of embedding the output material information D1 (“Yes” at step S96), the MFP 2 executes an output material information embedment output processing, which will be explained later (step S97).

On the other hand, when it is not the output processing of embedding the output material information D1 (“No” at step S96), the MFP 2 executes an output processing, which will be explained later (step S98).

Next, the notification controller 2011 of the MFP 2 determines whether or notification to the output user is set in the notification setting for the embedment administration setting (step S99). When the notification is not set (“No” at step S99), the MFP 2 moves to step S102.

On the other hand, when the notification is set (“Yes” at step S99), the MFP 2 executes the output user notification setting processing explained above (step S101).

Next, the recording controller 2004 of the MFP 2 determines whether or not recording of various kinds of logs is set for the detection log administration setting (step S102). When the recording of various kinds of logs is not set (“No” at step S102), the MFP 2 ends the output material information detecting processing.

On the other hand, when the recording of various kinds of logs is set (“Yes” at step S102), the recording controller 2004 of the MFP 2 records a corresponding log (step S103). In other words, the recording controller 2004 records the image data as an image log in the image log table T3 based on the detection log administration setting. The recording controller 2004 records a job log in the job log table T2 based on the detection log administration setting.

In the manner explained above, the MFP 2 ends the output material information detecting processing.

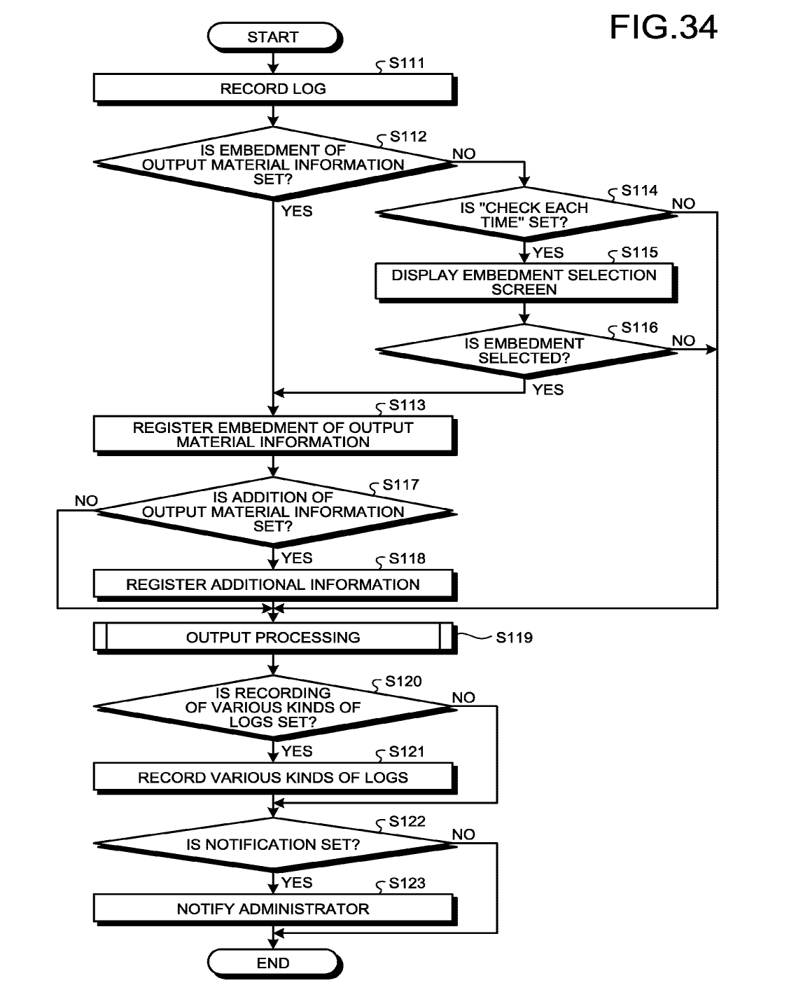

FIG. 34 is a flowchart of an example of the output material information embedment output processing to be executed by the MFP 2 according to the embodiment.

The recording controller 2004 of the MFP 2 records a log based on the embedment log administration setting (step S111).

Next, the output material information embedment unit 2012 of the MFP 2 determines whether or not “YES” is set for the embedment of the output material information D1 in the user's embedment administration setting (step S112).

When “YES” is set for the embedment of the output material information D1 (“Yes” at step S112), the output material information embedment unit 2012 of the MFP 2 registers embedding the output material information D1 (step S113).

On the other hand, when “NO” is set for the embedment of the output material information D1 (“No” at step S112), the output material information embedment unit 2012 of the MFP 2 determines whether or not “CHECK EACH TIME” in embedding the output material information D1 is set in the user's embedment administration setting (step S114). When “CHECK EACH TIME” in embedding the output material information D1 is not set (“No” at step S114), the MFP 2 moves to step S119.

On the other hand, when “CHECK EACH TIME” in embedding the output material information D1 is set (“Yes” at step S114), the display controller 2002 of the MFP 2 displays a screen for embedment selection G15 (step S115).

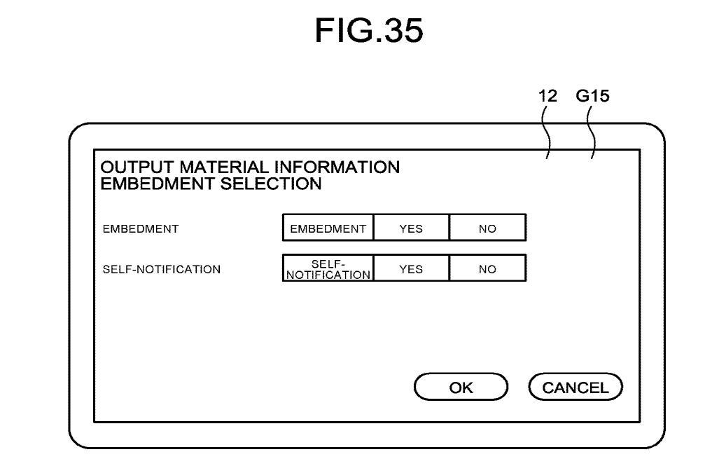

Here, FIG. 35 is an explanatory view of an example of the screen for embedment selection G15. The screen for embedment selection G15 is a screen which is displayed when “CHECK EACH TIME” in embedding the output material information D1 is set in the embodiment administration setting or the detection time output setting. The screen for embedment selection G15 receives an input of selecting one of “YES” and “NO” for the embedment of the output material information D1. The screen for embedment selection G15 also receives an input of selecting “YES” and “NO” for self-notification.

Next, the output material information embedment unit 2012 of the MFP 2 determines whether or not “YES” for the embedment of the output material information D1 is selected (step S116). When “NO” for the embedment of the output material information D1 is selected (“No” at step S116), the MFP 2 moves to step S119. On the other hand, when “YES” for the embedment of the output material information D1 is selected (“Yes” at step S116), the MFP 2 moves to step S113.

Next, the output material information embedment unit 2012 of the MFP 2 determines whether or not an addition of additional information is set for the administrator's output material information addition setting (step S117). When the addition of additional information is not set for the administrator's output material information addition setting (“No” at step S117), the MFP 2 moves to step S119.

On the other hand, when the addition of additional information is set for the administrator's output material information addition setting (“Yes” at step S117), the output material information embedment unit 2012 of the MFP 2 registers the addition of additional information to the output material information D1 (step S118).

Next, the MFP 2 executes an output processing to be explained later (step S119).

Next, the recording controller 2004 of the MFP 2 determines whether or not recording of various kinds of logs is set for the detection log administration setting or the output material information addition setting (step S120). When the recording of various kinds of logs is not set (“No” at step S120), the MFP 2 moves to step S122.

On the other hand, when the recording of various kinds of logs is set (“Yes” at step S120), the recording controller 2004 of the MFP 2 records a corresponding log (step S121). In other words, the recording controller 2004 records the image data as an image log in the image log table T3 based on the detection log administration setting or the output material information addition setting. The recording controller 2004 records a job log in the job log table T2 based on the detection log administration setting or the output material information addition setting.

The notification controller 2011 of the MFP 2 then determines whether or not notification to the administrator is set for the embedment log administration setting (step S122). When the notification to the administrator is not set (“No” at step S122), the MFP 2 ends the output material information embedment output processing.

When the notification to the administrator is set (“Yes” at step S122), the notification controller 2011 of the MFP 2 makes the notification to the administrator based on the notification setting for the embedment log administration setting (step S123). In other words, the notification controller 2011 makes the notification to the administrator by at least one of the mail transmission, the display on the operation panel 12, and the message transmission in the SNS based on the notification setting.

In the manner explained above, the MFP 2 ends the output material information embedment output processing.

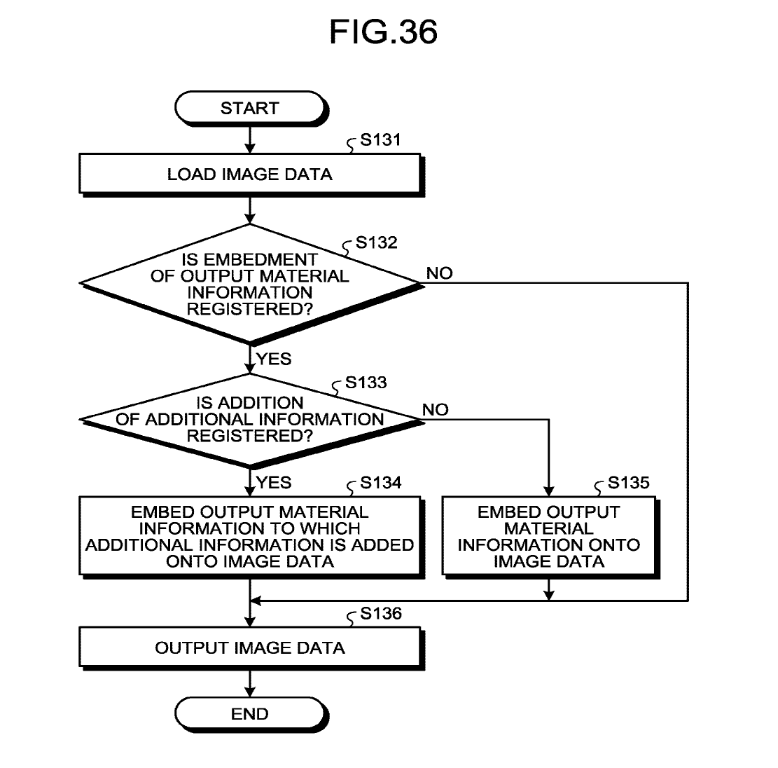

FIG. 36 is a flowchart of an example of the output processing to be executed by the MFP 2 according to the embodiment.

The image output unit 2013 of the MFP 2 loads image data as an output target in the primary storage unit 18 (step S131).

Next, the image output unit 2013 of the MFP 2 determines whether or not the embedment of the output material information D1 to the image data as the output target is registered (step S132). When the embedment of the output material information D1 is not registered (“No” at step S132), the MFP 2 moves to step S136.

On the other hand, when the embedment of the output material information D1 is registered (“Yes” at step S132), the image output unit 2013 of the MFP 2 determines whether or not an addition of additional information to the output material information D1 is registered (step S133).

When the addition of additional information to the output material information D1 is registered (“Yes” at step S133), the image output unit 2013 of the MFP 2 embeds the output material information D1 to which the additional information is added onto the image data (step S134).

On the other hand, when the addition of information to the output material information D1 is not registered (“No” at step S133), the image output unit 2013 of the MFP 2 embeds the output material information D1 onto the image data without adding additional information (step S135).

Next, the image output unit 2013 of the MFP 2 outputs the image data (step S136).

In the manner explained above, the MFP 2 ends the output processing.

As explained so far, in the MFP 2 according to the embodiment, when receiving a request for outputting image data, the image output unit 2013 embeds, onto the image data, the output material information D1 including a user ID for identifying a user who has performed the operation concerning the output request and outputs the embedded image data. The output material information detector 2009 detects the output material information D1 embedded onto the image data when a finder causes the output material whose collection is neglected to be scanned by the MFP 2. The notification controller 2011 then makes a notification to the user of het user ID included in the output material information D1. The MFP 2 according to the embodiment is therefore capable of notifying the user who has output the output material of the fact that the output material is detected.

While the functions of the units (the communication controller 2001, the display controller 2002, the operation controller 2003, the recording controller 2004, the user authentication unit 2005, the initial setting unit 2006, the mode controller 2007, the image input unit 2008, the output material information detector 2009, the information reference unit 2010, the notification controller 2011, the output material information embedment unit 2012, and the image output unit 2013) of the MFP 2 are realized when the CPU of the control unit 11 executes the control program PR1 and the like stored in the storage device (the secondary storage unit 19 and the like, for example), the present invention is not limited thereto and at least a part of the functions of the units of the MFP 2 may be realized by a dedicated hardware circuit (semiconductor integrated circuit and the like), for example.

While the functions of the units (the communication controller 3001 and the display controller 3002) of the information processing device 3 are realized when the CPU of the control unit 31 executes the control program PR2 and the like stored in the storage device (the secondary storage unit 36 and the like, for example), the present invention is not limited thereto and at least a part of the functions of the units of the information processing device 3 may be realized by a dedicated hardware circuit (semiconductor integrated circuit and the like), for example.

While the functions of the units (the communication controller 4001 and the recording controller 4002) of the server device 4 are realized when the CPU of the control unit 41 executes the control program PR3 and the like stored in the storage device (the secondary storage unit 46 and the like, for example), the present invention is not limited thereto and at least a part of the functions of the units of the server device 4 may be realized by a dedicated hardware circuit (semiconductor integrated circuit and the like), for example.

While a program to be executed in each of the devices according to the embodiment is provided by being preloaded in a storage medium (ROM or a storage unit) provided in each device, the present invention is not limited thereto. For example, the program may be provided by being recorded in a file of an installable format or of an executable format in a computer-readable recording medium such as a CD-ROM, a flexible disk (FD), a CD-R, and a DVD (Digital Versatile Disk) as a computer program product. Moreover, the storage medium is not limited to a medium which is independent from a computer or a built-in system and a storage medium that stores or temporarily stores, by downloading, the program transmitted via LAN and the Internet may be used.

The program to be executed in each of the devices according to the embodiment may be provided by being stored on a computer connected to a network such as the Internet and downloaded via the network or may be provided or distributed via a network such as the Internet. The program of each of the devices according to the embodiment may be provided by being preloaded in a ROM and the like.

According to the embodiment, there is an advantage in that a detection of an output material can be notified to a user who has output the output material.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An image forming apparatus comprising:
a first input controller configured to receive an input concerning a request for outputting image data;
an output controller configured to output the image data onto which identification information for identifying an input user who performs the input concerning the output request received by the first input controller is embedded;
a second input controller configured to receive an input of the image data;
a detector configured to detect the identification information from the image data received by the second input controller; and
a notifier configured to notify a fact that the image data is detected in a manner recognizable by the input user of the identification information when the identification information is detected by the detector from the image data.

2. The image forming apparatus according to claim 1, further comprising a first setting controller configured to make a setting to a detection mode in which the identification information embedded onto the image data is detected.

3. The image forming apparatus according to claim 1, further comprising a second setting controller configured to set an addition of additional information concerning the output of the image data to the identification information, wherein
the output controller outputs the image data onto which the identification information to which the additional information is added is embedded when the second setting controller sets the addition of the additional information, and
the notifier makes the notifying together with the additional information embedded onto the image data.

4. The image forming apparatus according to claim 1, further comprising a third setting controller configured to set a restriction of the output of the image data when the detector detects the identification information from the image data, wherein
the output controller restricts the output of the image data depending on the setting by the third setting controller when the detector detects the identification information from the image data.

5. The image forming apparatus according to claim 1, further comprising an identifier configured to identify the input user, wherein
the notifier notifies, when the input user indicated by the identification information detected by the detector from the image data and the input user identified by the identifier are different, the input user indicated by the identification information detected from the image data of the fact that the image data is detected.

6. The image forming apparatus according to claim 1, wherein the notifier notifies a preset administrator of the fact that the image data is detected when the detector detects the identification information from the image data.

7. The image forming apparatus according to claim 1, further comprising a fourth setting controller configured to set whether the input user of the identification information is displayed in a display when the identification information embedded onto the image data is detected.

8. The image forming apparatus according to claim 1, wherein the notifier makes the notifying to the input user of the identification information by transmitting, to an information processing device used by the input user, a message indicating that the image data is detected.

9. The image forming apparatus according to claim 1, wherein the notifier makes the notifying to the input user of the identification information by displaying a message indicating that the image data is detected.

10. A notification method comprising:
receiving, by an image forming apparatus, an input concerning a request for outputting image data;
outputting, by the image forming apparatus, the image data onto which identification information for identifying an input user who performs an operation concerning the output request received by the image forming apparatus at the receiving is embedded;
receiving, by the image forming apparatus, an input of the image data;
detecting, by the image forming apparatus, the identification information from the image data; and
notifying, by the image forming apparatus, a fact that the image data is detected in a manner recognizable by the input user of the identification information when the identification information is detected from the image data received by the image forming apparatus at the receiving of the input of the image data.
